(19) United States
(12) Patent Application Publication
(10) Pub. No.: US 2025/0171020 A1
(43) Pub. Date: May 29, 2025

(54) SPEED LIMIT FUSION FOR AUTOMOTIVE SYSTEMS AND APPLICATIONS

(71) Applicant: NVIDIA Corporation, Santa Clara, CA (US)

(72) Inventors: Akash Chandra Shekar, Redmond, WA (US); Arun Kumar Varadarajan, Walled Lake, MI (US); Jeffrey Chun-Hin Liu, Bellevue, WA (US); Russell Chreptyk, Seattle, WA (US); Matthew Ashman, Redmond, WA (US); Jia Cheng, Monroe, WA (US); Youding Zhu, Sammamish, WA (US)

(21) Appl. No.: 18/519,824

(22) Filed: Nov. 27, 2023

(51) Int. Cl. B60W 30/14; B60W 60/00; G08G 1/01

(52) U.S. Cl. CPC B60W 30/146; B60W 60/001; G08G 1/0129; B60W 2555/60; B60W 2556/10

(57) ABSTRACT

In various examples, systems and methods of the present disclosure correspond to speed limit fusion for automotive systems and applications. Systems and methods are disclosed that fuse speed limit data from both one or more map sources (e.g., nav-maps, HD maps, SD maps, etc.) and a perception system, and that employ rules to help resolve conflicts in speed limits from the perception system and the map(s). For example, if a conflict occurs, the rules may indicate whether to use the speed limit data from the perception data, the speed limit data from the map(s), and/or whether to use another type of speed limit data, such as cached speed limit data.

### BACKGROUND

Vehicles—such as semi-autonomous vehicles and autonomous vehicles—often rely on speed limit information for path planning, vehicle control, and/or other processes. In some systems, the speed limit information for a current location is determined using perception systems of the vehicle. For example, vehicles equipped with perception systems—e.g., cameras, LiDAR, RADAR, etc.—may use one or more deep neural networks (DNNs) to process perception data in order to determine speed limits. In some instances, vehicles may also obtain local speed limit data from navigation maps (“nav-maps”), standard definition (SD) maps, high definition (HD) maps, and/or other map types. One example of a nav-map is the Advanced Driver Assistance Systems Interface Specifications (ADASIS), which is a predictive map-based driver assistance system. However, in some circumstances, perception systems and nav-maps, relied upon individually, are not completely reliable sources of local speed limit data.

For example, the accuracy of speed limit data in perception systems is limited by the training data and the underlying DNN architecture, and a perception system may fail to read certain road signs correctly and/or the road signs may be occluded, damaged, etc., which may lead to inaccurate perception information. As another example, a perception system may identify the vehicle as being in an incorrect lane, e.g., a lane other than that in which the vehicle is traveling. As a result, any speed limit sign to lane associations may be interpreted incorrectly, and the vehicle may rely on speed limit information for an incorrect lane of travel. Nav-maps may also present certain limitations; for example, the speed limit data in a nav-map may be out of date, and certain portions of a given city may not be mapped at all. In view of such limitations of a perception system by itself, and of a nav-map by itself, there is a need for improving accuracy of speed limit data that may be acted upon by an autonomous vehicle or by a driver of a semi-autonomous vehicle.

### SUMMARY

Embodiments of the present disclosure relate to speed limit fusion for automotive systems and applications. Systems and methods are disclosed that fuse speed limit data from both one or more map sources (e.g., nav-maps, HD maps, SD maps, etc.) and a perception system, and that employ rules to help resolve conflicts in speed limits from the perception system and the map(s). For example, if a conflict occurs, the rules may indicate whether to use the speed limit data from the perception data, the speed limit data from the map(s), and/or whether to use another type of speed limit data, such as cached speed limit data.

In contrast to conventional systems, such as those described above that use either a perception system by itself or a map by itself to obtain local speed limit data, the current systems, in some embodiments, obtain speed limit data from both sources and then apply one or more rules to publish accuracy-enhanced speed limit data that is then acted upon by an autonomous vehicle, or provided to a driver of a vehicle. For example, and for a speed limit sign, the current systems may determine at least a first speed limit using a perception system and a second speed limit using a map(s). The current system may then determine, using the rule(s), a final speed limit using both the first speed limit and the second speed limit. By using the speed limit data from both sources to determine the final speed limit associated with the speed limit sign, the current systems, in some embodiments, may more accurately determine speed limits for vehicles navigating within environments.

### BRIEF DESCRIPTION OF THE DRAWINGS

The present systems and methods for speed limit fusion for automotive systems and applications are described in detail below with reference to the attached drawing figures, wherein:

FIG. 1 illustrates an example data flow diagram for a process of fusing data from multiple sources to determine a speed limit associated with a speed limit sign, in accordance with some embodiments of the present disclosure;

FIG. 2A is a diagram of a map of an environment, in accordance with some embodiments of the present disclosure;

FIG. 2B is a diagram of an environment, in which a vehicle is traveling past a first speed limit sign in a first direction on a first road, the vehicle equipped with a fusion component, in accordance with some embodiments of the present disclosure;

FIG. 2C is a diagram similar to FIG. 2B, except showing the vehicle of FIG. 2B traveling in a second direction on a second road, the vehicle equipped with a fusion component, in accordance with some embodiments of the present disclosure;

FIG. 2D is a diagram of a second environment, in which the vehicle of FIG. 2B is shown traveling in a third direction on a third road, the vehicle equipped with a fusion component, in accordance with some embodiments of the present disclosure;

FIGS. 3A-3B are examples of using one or more rules to fuse speed limit data from a perception system with speed limit data associated with a map, in accordance with some embodiments of the present disclosure;

FIG. 4 is a flow chart providing an overview of an algorithm executed by a fusion component, and by associated input and output units, in accordance with some embodiments of the present disclosure;

FIG. 5 is a flow chart illustrating a series of processing operations represented by block 408 in FIG. 4, in accordance with some embodiments of the present disclosure;

FIG. 6 is a block diagram representing a rule book electronically stored in a memory unit, in accordance with some embodiments of the present disclosure;

FIG. 7 is a flow chart illustrating a method for determining a final speed limit from at least a first speed limit based on sensor data and a second speed limit based on map data, in accordance with some embodiments of the present disclosure.

FIG. 8A is an illustration of an example autonomous vehicle, in accordance with some embodiments of the present disclosure;

FIG. 8B is an example of camera locations and fields of view for the example autonomous vehicle of FIG. 8A, in accordance with some embodiments of the present disclosure;

FIG. 8C is a block diagram of an example system architecture for the example autonomous vehicle of FIG. 8A, in accordance with some embodiments of the present disclosure;

FIG. 8D is a system diagram for communication between cloud-based server(s) and the example autonomous vehicle of FIG. 8A, in accordance with some embodiments of the present disclosure;

FIG. 9 is a block diagram of an example computing device suitable for use in implementing some embodiments of the present disclosure; and

FIG. 10 is a block diagram of an example data center suitable for use in implementing some embodiments of the present disclosure.

### DETAILED DESCRIPTION

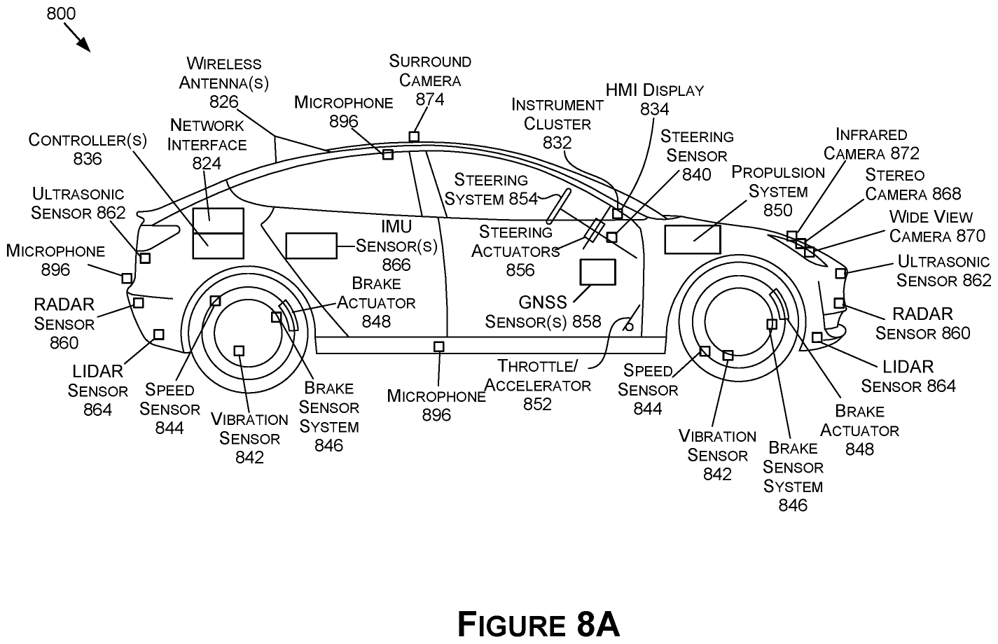

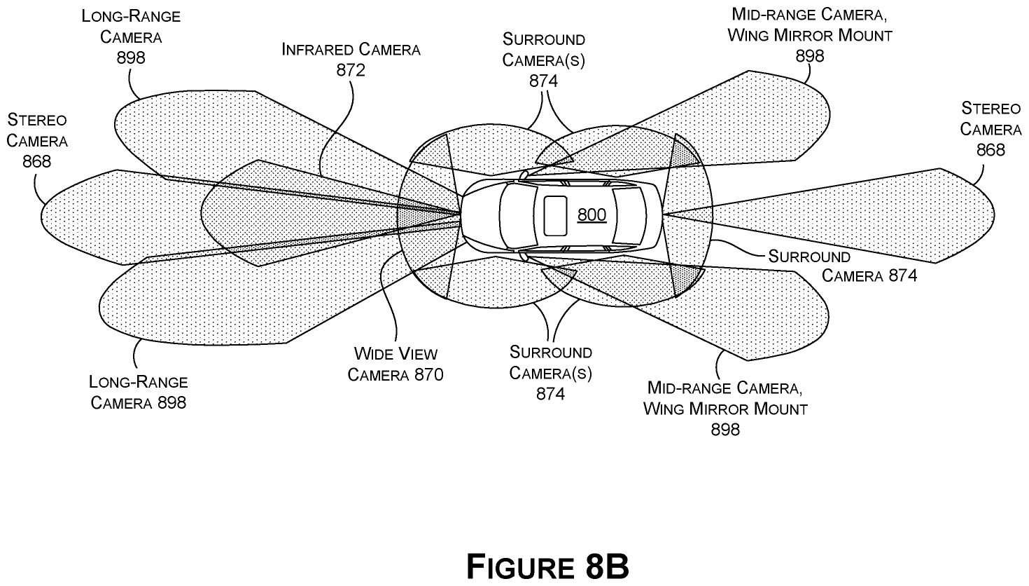

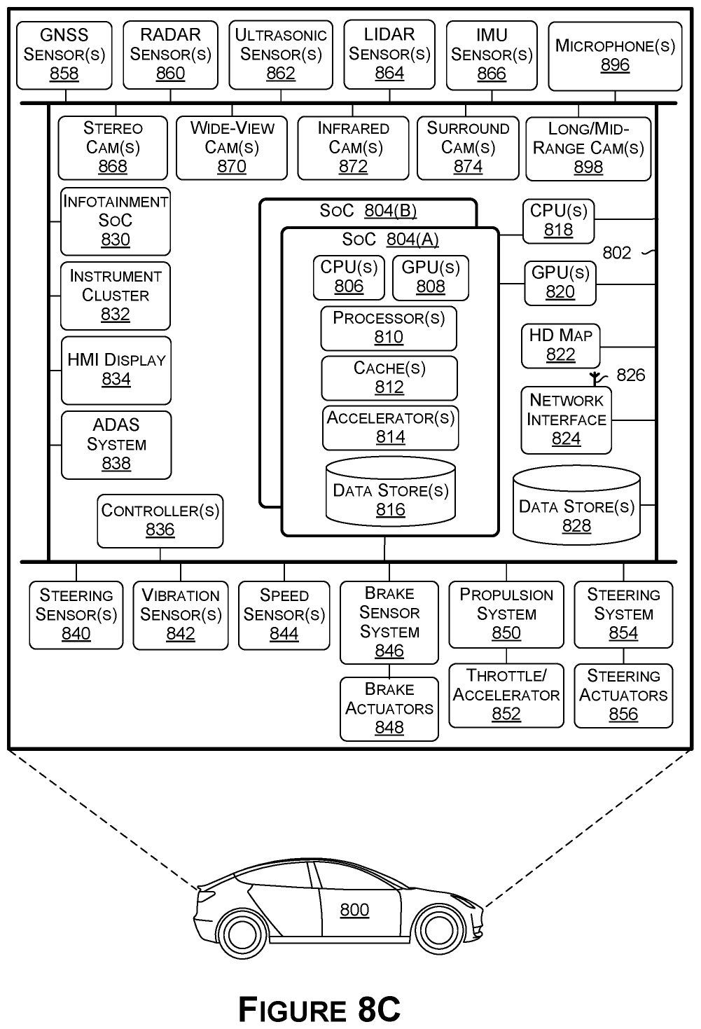

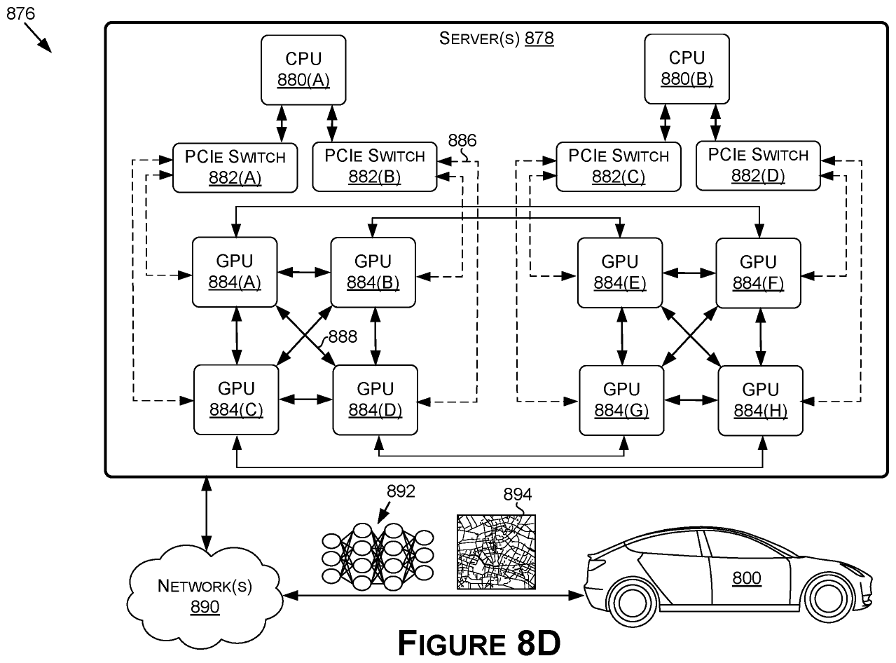

Systems and methods are disclosed related to speed limit fusion for automotive systems and applications. Although the present disclosure may be described with respect to an example autonomous or semi-autonomous vehicle 800 (alternatively referred to herein as “vehicle 800,” “ego-vehicle 800,” “machine 800,” or “ego-machine 800,” an example of which is described with respect to FIGS. 8A-8D), this is not intended to be limiting. For example, the systems and methods described herein may be used by, without limitation, non-autonomous vehicles, semi-autonomous vehicles (e.g., in one or more adaptive driver assistance systems (ADAS), autonomous vehicles, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to obtaining speed limit data for autonomous or semi-autonomous vehicles, this is not intended to be limiting, and the systems and methods described herein may be used in augmented reality, virtual reality, mixed reality, robotics, security and surveillance, autonomous or semi-autonomous machine applications, and/or any other technology spaces where analysis and publication of speed limit data (and/or other data types of data where two sources of information may be relied upon) may be used.

Systems and methods of the present disclosure may obtain speed limit data from both a perception system and a map (e.g., a nav-map, an HD map, an SD map, a Most Probable Path (MPP) map, etc.) together and then apply one or more rules to publish accuracy-enhanced speed limit data that may be acted upon by a vehicle (e.g., an autonomous vehicle, a semi-autonomous vehicle, a robot, machinery, etc.) and/or by a driver of the vehicle. Speed Limit Fusion (SLF) may include a process for gathering speed limits from two or more sources-such as both the perception system and the map-resolving any conflicts in data gathered from those two sources, and then publishing the most accurate speed limit for a world model (WM) lane (also called “ego-lane”) that represents the lane where the vehicle is positioned. SLF may, for example, depend upon a confidence value associated with, and the age of, a perception speed limit to resolve speed limit conflicts. In some non-limiting embodiments, SLF may publish speed limits only for lanes reachable from the ego-vehicle, such lanes including the ego-lane, forks of the ego-lane, and immediate neighbors of the ego-lane. Speed limits are published in ego-space with the proper lane assignment and entry and exit offsets indicating the range of the lane where speed limits apply.

For example, a system(s) (e.g., a fusion component) may use a confidence value (score) and age of a speed limit from the perception system to resolve speed limit conflicts. When comparing speed limit data obtained from each source, the system(s) may ensure that the speed limit data from each source corresponds to the same coordinate space, allowing for a simpler comparison of speed limit data from those sources. Such assurance may be achieved through defining a coordinate space as an “offset,” which is a cumulative distance along the ego-lane from the vehicle (also called “ego-vehicle” or “ego-car”). The system(s) may associate a lane with an offset governed by a given speed limit, and with a speed limit ahead of the ego-lane. The system(s) may publish speed limits in ego-space only for lanes reachable from the vehicle, including the ego-lane, forks of the ego-lane, and immediate neighbors of the ego-lane. A published speed limit may thus be associated with the proper lane assignment, together with entry and exit offsets that indicate the range of the lane to which the published speed limit applies.

For instance, the system(s) may determine a first speed limit associated with a lane using the perception system and a second speed limit associated with the lane using the map. The system(s) may then determine whether the first speed limit corresponds to (e.g., matches) the second speed limit. Based at least on determining that the first speed limit corresponds to the second speed limit, the system(s) may determine that a final speed limit includes the first speed limit and/or the second speed limit. However, based at least on determining that the first speed limit does not correspond to (e.g., does not match) the second speed limit, then system(s) may use one or more rules for determining the final speed limit.

For a first example, if the system(s) determines that the perception determined the first speed limit with a confidence that satisfies (e.g., is equal to or greater than) a threshold confidence, then the system(s) may determine to use the first speed limit as the final speed limit for the road. In this first example, the system(s) may use one or more additional factors when making the determination, such as the age of the first speed limit (e.g., a time period since the perception system determined the first speed limit, a distance the vehicle has traveled since the perception system determined the first speed limit, etc.), a type of road (e.g., a highway, a rural area, etc.), and/or any other information. For instance, if the system(s) determines that the time period since the perception system determined the first speed limit exceeds some threshold time period and/or the distance the vehicle has traveled since the perception system determined the first speed limit exceeds some distance threshold (e.g., the offset), then the system(s) may determine to use the second speed limit as the final speed limit.

For a second example, if the system(s) determines that a path of the vehicle has changed, such as the vehicle turning onto a new road, then the system(s) may determine to use the second speed limit as the final speed limit. In some examples, the system(s) may determine to use this second speed limit until the perception system determines a new speed limit (e.g., with a confidence that satisfies the threshold confidence) while navigating along this new path. While these are just a couple example techniques that the system(s) may use to determine the final speed limit when the first speed limit does not correspond to the second speed limit, in other examples, the system(s) may use additional and/or alternative techniques.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, autonomous or semi-autonomous machine applications, deep learning, environment simulation, object or actor simulation and/or digital twinning, data center processing, conversational AI, light transport simulation (e.g., ray tracing, path tracing, etc.), collaborative content creation for 3D assets, cloud computing, generative AI, (large) language models, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, systems for performing generative AI operations, systems implementing—or for performing operations using—a large language model (LLM), and/or other types of systems.

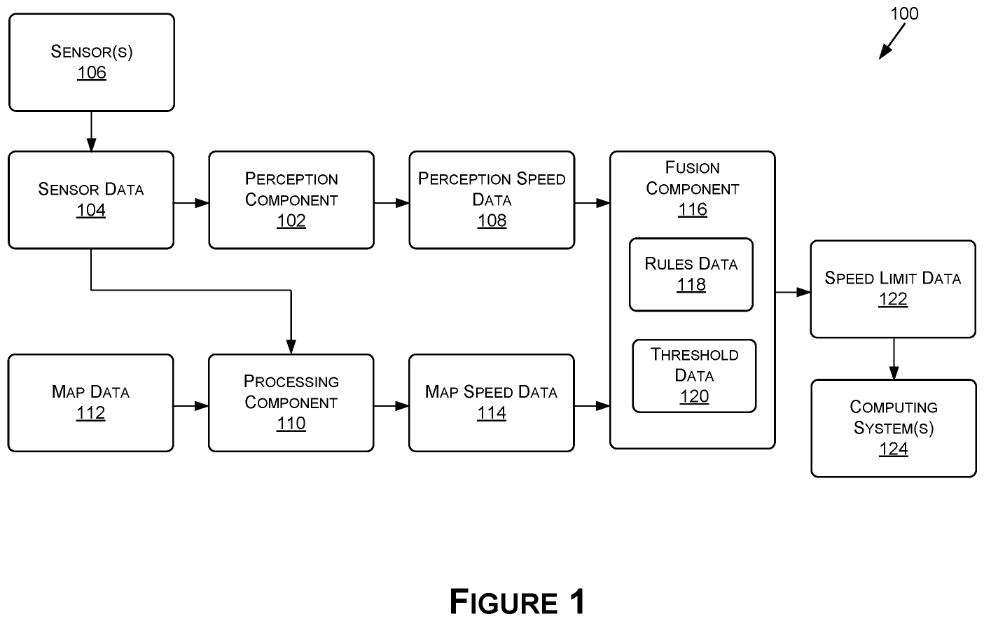

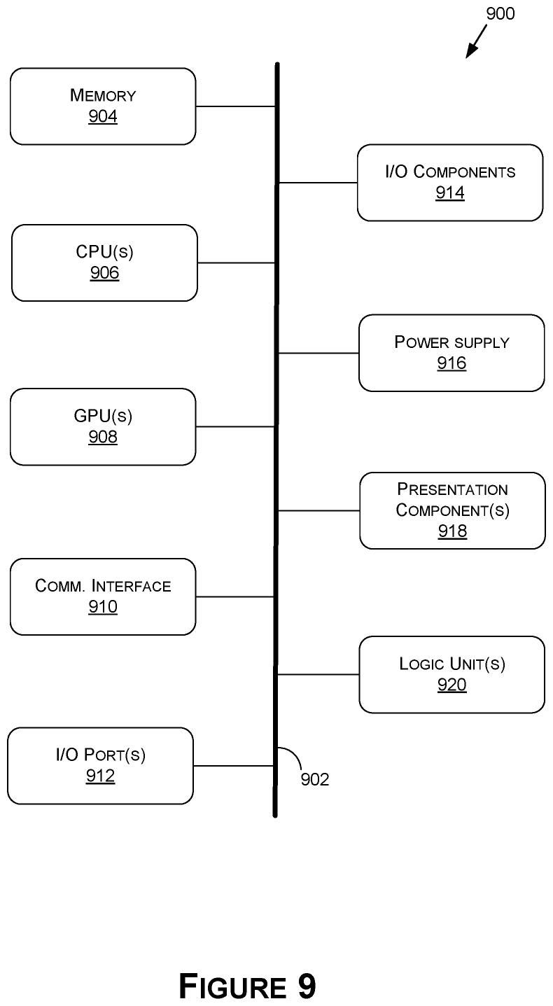

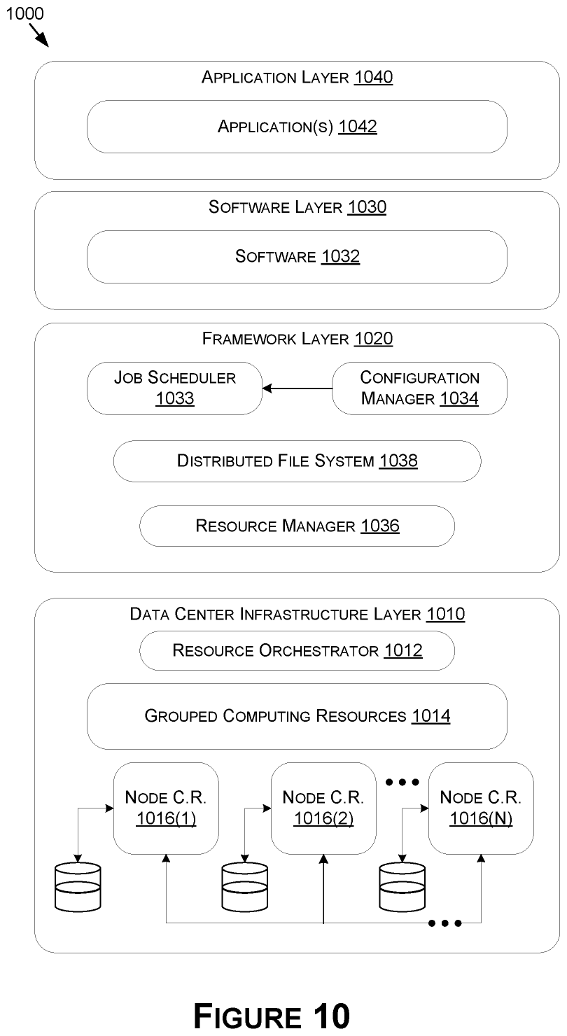

FIG. 1 illustrates an example data flow diagram for a process of fusing data from multiple sources to determine a speed limit associated with a speed limit sign, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 800 of FIGS. 8A-8D, example computing device 900 of FIG. 9, and/or example data center 1000 of FIG. 10.

The process 100 may include a perception component 102 (e.g., a perception system) receiving sensor data 104 from one or more sensors 106. As described herein, a sensor 106 may include, but is not limited to, an image sensor (e.g., a camera), a LiDAR sensor, a RADAR sensor, a location sensor (e.g., a Global Positioning System (GPS) sensor, etc.), an ultrasonic sensor, and/or any other type of sensor. As such, the sensor data 104 may include image data, video data, LiDAR data, RADAR data, location data (e.g., GPS data), ultrasonic data, and/or any other type of sensor data. The perception component 102 may include functionality to perform object detection, segmentation (e.g., object, instance, etc.), classification, tracking, and/or other processes. For instance, the perception component 102 may output data indicating detected lanes and boundaries on driving surfaces, detected drivable free-space, detect poles or signs, detected traffic lights, detected traffic signs (e.g., speed limit signs), detect objects in the environment (e.g., vehicles, pedestrians, animals, inanimate objects, etc.), detected wait conditions and intersections, and/or the like. In additional or alternative examples, the perception component 102 may generate data that indicates one or more characteristics associated with a detected object and/or the environment in which the object is positioned. The characteristics associated with an object may include, but are not limited to, an x-position (global and/or local position), a y-position (global and/or local position), a z-position (global and/or local position), an orientation (e.g., a roll, pitch, yaw), an object classification (e.g., a type of object), a velocity, an acceleration, an extent of the object (size), etc.

In those examples in which the perception component 102 performs detection, the perception component 102 may generate data that indicates detections of objects detected in an image. Such detections may comprise two-dimensional (2D) and/or three-dimensional (3D) bounding shapes (e.g., bounding boxes, bounding cuboids, etc.), volumes, and/or masks of detected objects. Additionally, in some examples, the data may indicate a probability (e.g., a confidence) associated with an object, such as a probability associated with a location of the object, a classification of the object, and/or the like. In some examples, the detection of the perception component 102 may use a machine learning approach (e.g., scale-invariant feature transform (SIFT), histogram of oriented gradients (HOG), etc.) followed by a support vector machine (SVM) to classify objects depicted in images represented by the sensor data 106. Additionally, or alternatively, detection may use a deep learning approach based on a convolutional neural network (CNN) to classify objects depicted in images represented by the sensor data 106.

For instance, such as if the sensor data 104 is image data representing one or more images depicting a speed limit sign, the perception component 102 may process the image data in order to determine information associated with the speed limit sign. As described herein, the information may include at least a speed limit (referred to, in some examples, as a “first speed limit” or a “perception speed limit”) associated with the speed limit sign, a probability associated with the first speed limit, and/or any other information. For example, if the speed limit sign is a 50 miles per hour (MPH) speed limit sign, then the perception component 102 may process the image data in order to detect the sign and/or the text “50 MPH” or “Speed Limit 50 MPH.” The perception component 102 may then use that detection to determine that the speed limit sign includes a 50 MPH speed limit sign. Additionally, the perception component 102 may determine a probability that the speed limit sign includes the 50 MPH sign, such as 50%, 75%, 90%, 95%, 99%, and/or the like.

The process 100 may include the perception component 102 then generating and/or outputting perception speed data 108 representing the information associated with the speed limit sign. For example, and using the example above where the perception component 102 detects the 50 MPH speed limit sign, the perception speed data 108 may indicate that the speed limit sign includes the 50 MPH speed limit sign, that the speed zone associated with the environment for which the vehicle is navigating is 50 MPH, and/or the probability associated with the speed limit sign including the 50 MPH speed limit sign.

The process 100 may include a processing component 110 processing map data 112 in order to determine another speed limit (referred to, in some examples, as a “second speed limit” or “map-based speed limit”) associated with the speed limit sign. For instance, the processing component 110 may use one or more processes to determine a pose of vehicle within an environment. In some examples, the processing component 110 determines the pose using at least a portion of the sensor data 104, such as location data (e.g., GPS data) generated by a location sensor. Additionally, or alternatively, in some examples, the processing component 110 determines and/or refines the pose using additional sensor data 104—such as through a localization process. For example, the processing component 110 may determine and/or update the initial pose of the vehicle using image data, LiDAR data, RADAR data, and/or the like. For instance, to refine the initial pose, the processing component 110 may compare one or more features represented by the additional sensor data 104 to one or more features represented by the map data 112, where the map data 112 represents a map of an environment for which the vehicle is located. Based at least on the comparing, the processing component 110 may update the initial pose of the vehicle to an estimated pose (e.g., a localization pose) of the vehicle within the environment. As described herein, a pose may represent a location (e.g., a x-coordinate location, a y-coordinate location, and/or a z-coordinate location) of the vehicle, an orientation (e.g., a yaw, a pitch, and/or a roll) of the vehicle, and/or any other location, pose, or orientation information.

The processing component 110 may then analyze the map data 112, using the determined pose, to identify the speed limit sign as represented by the map data 112. For example, the processing component 110 may determine that the speed limit sign is located along the path of the vehicle and/or associated with the lane for which the vehicle is navigating. Additionally, the processing component 110 may determine the second speed limit sign using the map data 112. For example, and as described herein, the map data 112 may representing information associated with the environment, such as speed limits associated with speed limit signs located within the environment. As shown, the process 100 may then include the processing component 110 generating and/or outputting map speed data 114 representing at least the second speed limit associated with the speed limit sign.

The process 116 may include a fusion component 116 processing the perception speed data 108 and the map speed data 114 and, based at least on the processing, determining a final speed limit (e.g., a fused speed limit) associated with the speed limit sign. For instance, and as described herein, the fusion component 116 may initially be associated with the first speed limit for the speed limit sign with the second speed limit for the speed limit sign. In some examples, the fusion component 116 may associate the speed limits based at least on the perception component 102 and the processing component 110 indicating that the speed limit signs are associated with the same path, such as the same road and/or lane, for which the vehicle is navigating. In some examples, the fusion component 116 may associate the speed limits based at least on the first speed limit being the last speed limit determined by the perception component 102 and the second speed limit being the last speed limit determined by the processing component 110. While these are just two example techniques of how the fusion component 116 may associated with the speed limits, in other examples, the fusion component 116 may use additional and/or alternative techniques to associate the speed limits.

As described herein, the fusion component 116 may then use the perception speed data 108, the map speed data 114, an age associated with the perception speed data 108, road information (which may be represented by the map speed data 114), and/or one or more rules to determine the final speed limit using at least the first speed limit represented by the perception speed data 108 and the second speed limit represented by the map speed data 114, where the rule(s) is represented by rules data 118. For instance, if the fusion component 116 determines that the first speed limit corresponds to (e.g., matches) the second speed limit, then the fusion component 116 may use a first rule that the final speed limit includes the first speed limit and/or the second speed limit. However, if the fusion component 116 determines that the first speed limit does not correspond to (e.g., does not match) the second speed limit, then the fusion component 116 may use one or more additional rules to determine the first speed limit.

For a first example, the fusion component 116 may use a second rule indicating that the final speed limit includes the first speed limit based at least on the first speed limit including a probability (e.g., a confidence) that satisfies (e.g., is equal to or greater than) a threshold probability (which is represented by threshold data 120), or determine to use the second speed limit when the probability does not satisfy (e.g., is less than) the threshold probability. As described herein, the threshold probability may include, but is not limited to, 75%, 90%, 95%, 99%, and/or any other probability. For a second example, the fusion component 116 may use a third rule indicating that the final speed limit includes the first speed limit based at least on the first speed limit including an age that satisfies a threshold age (which may correspond to the offsets described herein) (which is also represented by the threshold data 120), or determine to use the second speed limit when the age does not satisfy the threshold age. As described herein, the age may be associated with a distance traveled since the perception component 102 determined the first speed limit and/or a time period that has elapsed since the perception component 102 determined the first speed limit. For instance, the age may satisfy the threshold age when the distance traveled is less than or equal to a threshold distance (e.g., 5 meters, 10 meters, 50 meters, 100 meters, etc.) (which is also represented by the threshold data 120) or determine that the age does not satisfy the threshold age when the distance traveled is greater than the threshold distance. Additionally, the age may satisfy the threshold age when the time period is less than or equal to a threshold time period (e.g., 5 seconds, 10 seconds, 50 seconds, 100 seconds, etc.) (which is also represented by the threshold data 120) or determine that the age does not satisfy the threshold age when the time period is greater than the threshold time period.

For a third example, the fusion component 116 may determine whether a path of the vehicle has changed since the perception component 102 determined the first speed limit. In some examples, the fusion component 116 may determine that the path of the vehicle changes based at least on the vehicle turning, selecting a lane when there is a fork within the road, and/or navigates any other path that may change the speed limit. If the fusion component 116 determines that the vehicle has not changed path (e.g., has continued navigating along a same lane), and the probability of the first speed limit satisfies the threshold probability and/or the age of the first speed limit satisfies the first age, then the fusion component 116 may use a fourth rule indicating that the final speed limit includes the first speed limit. However, if the fusion component 116 determines that the vehicle has changed path (e.g., the vehicle has turned), and even if the probability of the first speed limit satisfies the threshold probability and the age of the first speed limit satisfies the first age, then the fusion component 116 may use the fourth rule further indicating that the final speed limit includes the second speed limit.

For a fourth example, the fusion component 116 may determine that the perception speed data 108 indicates that the perception component 102 has detected a traffic sign associated with a temporary speed limit, such as a construction sign, an emergency sign, and/or any other traffic sign that may change a speed limit. The fusion component 116 may then use a fifth rule indicating that the final speed limit includes the first speed limit that is associated with the traffic sign indicating the temporary speed limit. In some examples, the fusion component 116 may determine to use the first speed limit since the map data 112 may not have been updated to indicate the temporary change in speed limit.

While the first two examples describe the fusion component 116 using the first speed limit determined using the perception component 102 when there is a conflict between the first speed limit and the second speed limit determined using the processing component 110, and the probability satisfies the threshold probability and/or the age satisfies the threshold age, in other examples, the fusion component 116 may use the second speed limit. For instance, in such examples, the fusion component 116 may use the second speed limit based on the map speed data 112 representing a specific type of map, such as a high-definition map, where the speed limits signs are continuously updated and/or known to be accurate. While these are just a couple example rules that the fusion component 116 may use to fuse the speed limits, in other examples, the fusion component 116 may use additional and/or alternative rules.

The process 100 may then include the fusion component 116 generating and/or outputting speed limit data 122 representing the final speed limit associated with the speed limit sign, such as to one or more computing systems 124 associated with the vehicle and/or other system. For a first example, such as when the computing system(s) 124 is associated with the vehicle, the computing system(s) 124 may use the speed limit data 122 when determining one or more operations for navigating the vehicle within the environment. For example, the computing system(s) 124 may cause the vehicle to navigate at the final speed limit (e.g., when safe to do so) represented by the speed limit data 122. For a second example, such as when the computing system(s) 124 is associated with one or more systems that generate the map speed data 112, the computing system(s) 124 may use the speed limit data 122 to update the map speed data 112. For example, if the speed limit data 122 indicates that the speed limit for the speed limit sign is incorrect (e.g., the speed limit was changed since the map was last updated), then the computing device(s) 124 may update the map data 112 to indicate the final speed limit.

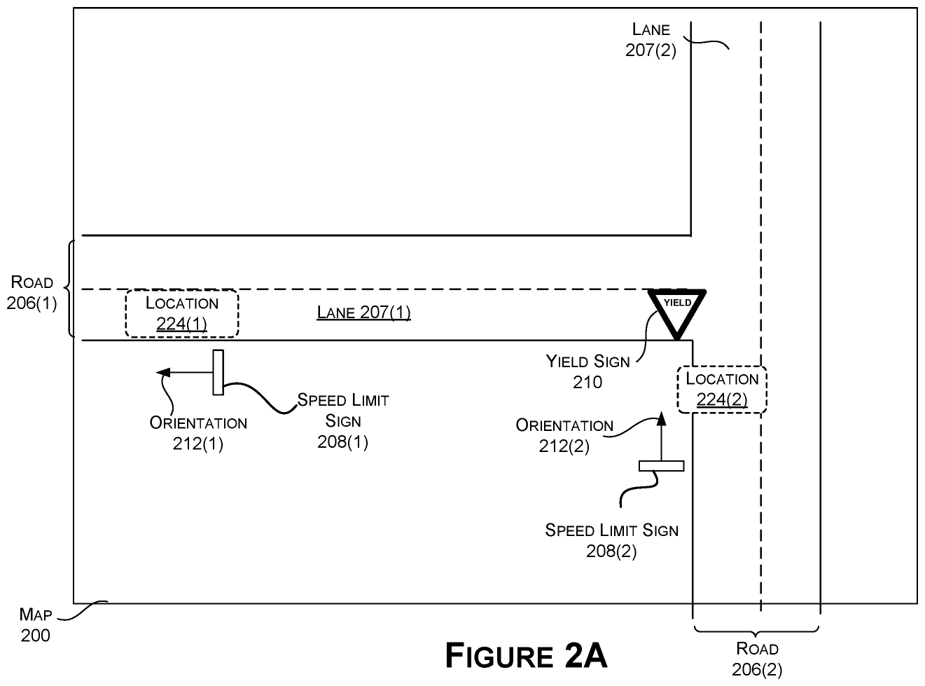

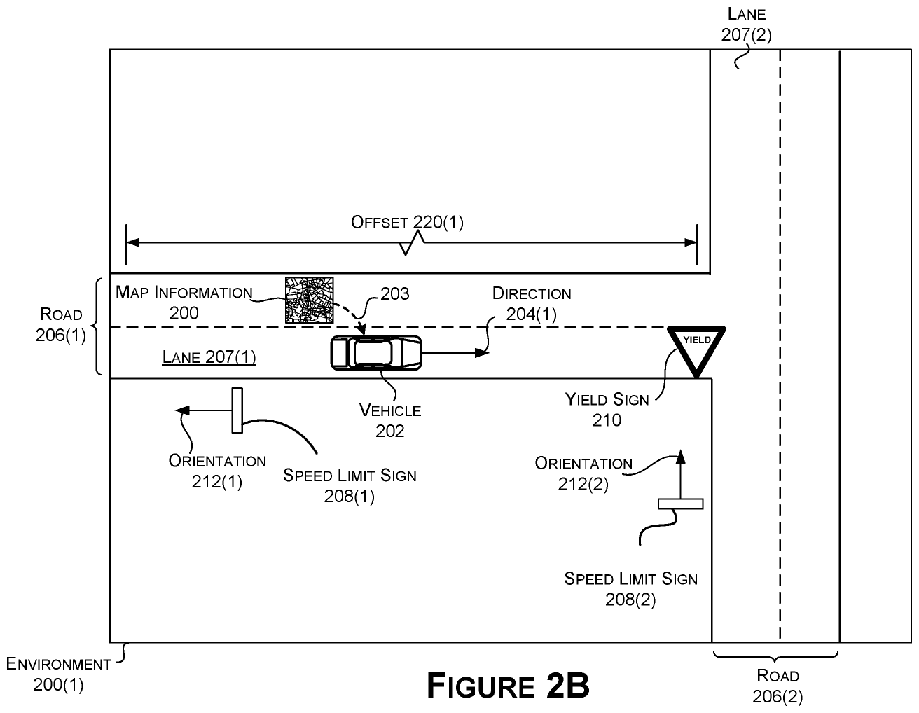

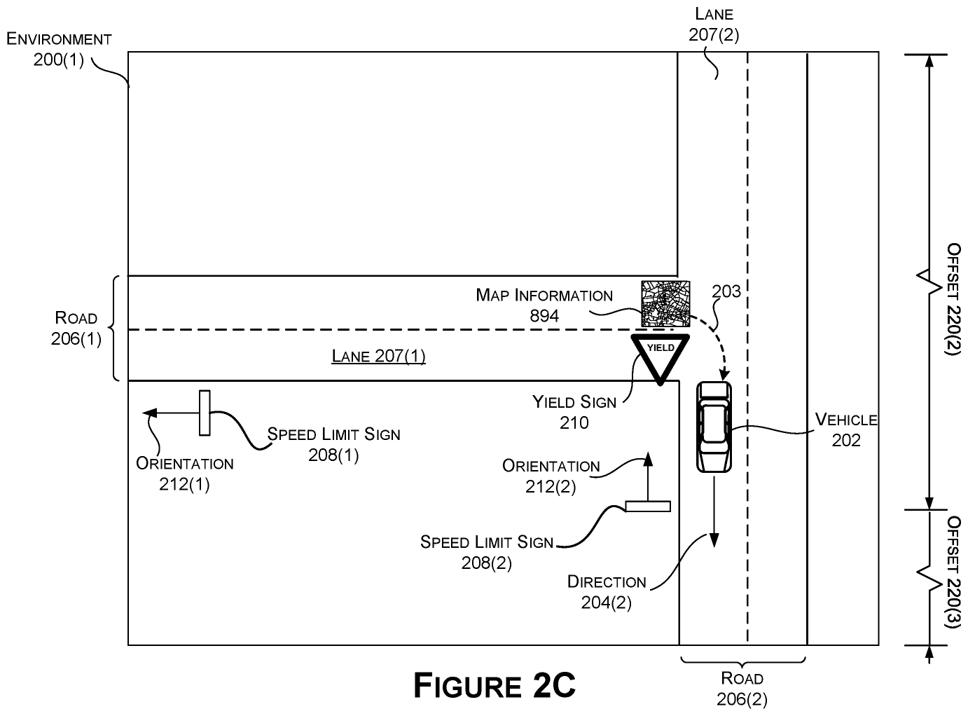

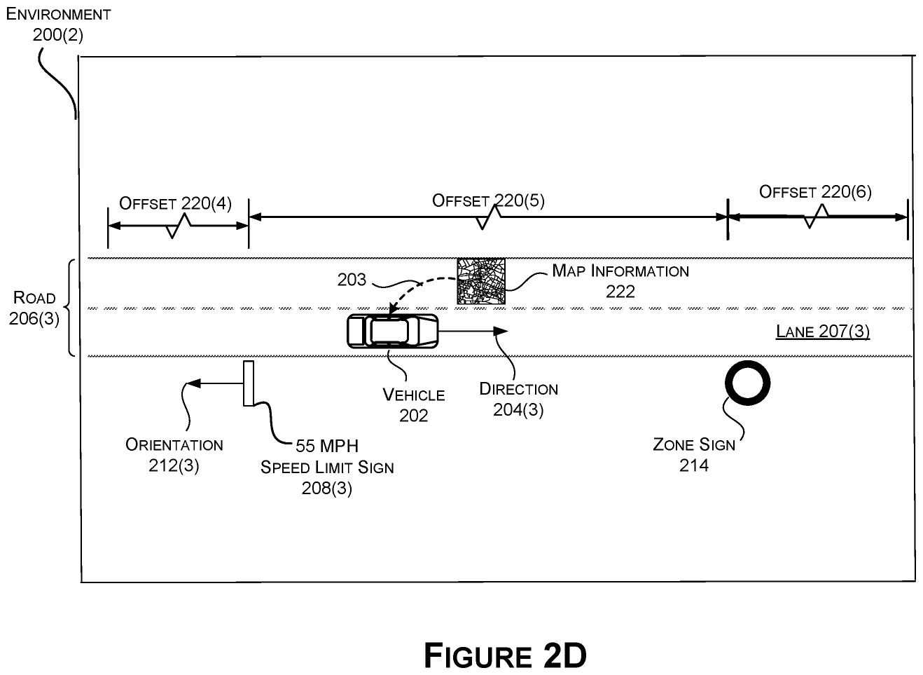

FIG. 2A is a diagram of a map 200 of an environment 200(1) (illustrated at least in FIG. 2B), in accordance with some embodiments of the present disclosure. The environment 200(1) comprises a first road 206(1) with a first lane of travel 207(1) (“first lane 207(1)”), the first road 206(1) intersecting with a second road 206(2), the second road including a second lane of travel 207(2) (“second lane 207(2)”). The first lane 207(1) is associated with a first speed limit sign 208(1) and a yield sign 210, and the second lane 207(2) is associated with a second speed limit sign 208(2). According to the map 200, the first speed limit sign 208(1) may recite a speed limit of 35 MPH, and assumes an orientation 212(1) that is normal to a front face of the first speed limit sign 208(1) extends in a direction substantially parallel to a direction of travel along the first lane 207(1). Although the yield sign 210 is shown with its front face visible to one viewing FIG. 2A, it is to be understood that the yield sign 210 bears the same orientation with respect to the first lane 207(1) as does the first speed limit sign 208(1). Similarly, according to the map 200, the second speed limit sign 208(2) may recite a speed limit of 45 MPH, and assumes an orientation 212(2) such that a line normal to a front face of the second speed limit sign 208(2) extends in a direction substantially parallel to the direction of travel along the second lane 207(2).

In the example of FIG. 2A, a vehicle 202 (e.g., illustrated at least in FIG. 2B) may use the map 200 to determine speed limits associated with the speed limit signs 208(1)-(2). For instance, the vehicle 202 may use sensor data (e.g., sensor data 104) to determine a location of the vehicle with respect to the map 200. The vehicle 202 may then use the location to determine the speed limits. For a first example, if the vehicle 202 determines that a location 224(1) of the vehicle 202 is on the first road 206(1) and/or in the first lane 207(1), then the vehicle 202 may use the map 200 to determine the speed limit associated with the speed limit sign 208(1) (e.g., the speed limit is 35 MPH). For a second example, if the vehicle 202 determines that a location 224(2) is on the second road 206(2) and/or in the second lane 207(2), then the vehicle 202 may use the map 200 to determine the speed limit associated with the second speed limit sign 208(2) (e.g., a speed limit of 45 MPH).

FIG. 2B is a diagram of the first environment 200(1), in which the vehicle 202 is traveling in a first direction 204(1) on the first lane 207(1) of the first road 206(1). The vehicle 202 is equipped with the fusion component 116 in accordance with some embodiments of the present disclosure and, if autonomous or semi-autonomous, vehicle 202 may also possess some or all of the features discussed herein with regard to vehicle 800 of FIGS. 8A-8D. In FIG. 2B, vehicle 202 is shown using a perception system (such as the perception component 102 and/or the ADAS 838 of FIG. 8C) to read the yield sign 210, and is receiving additional speed limit data as map information 200 from the map of FIG. 2A. The map information 200 and its transmission (arrow 203) to a vehicle 800 are discussed in greater detail with regard to FIG. 8D. From that discussion, it will be understood that the term “map information” encompasses HD map data, SD map data, and/or nav-map data. Therefore, although examples discussed herein focus mostly map information in the form of nav-map data, other embodiments of the present disclosure may obtain map data in HD map form instead of nav-map data. In FIG. 2B, the vehicle 202 has already driven past the first speed limit sign 208(1).

In the example of FIG. 2B, the fusion component 116 has associated the first lane 207(1) with a first offset 220(1) that is a cumulative distance along an ego-lane (corresponding to the first lane 207(1)) from an ego-vehicle representing the vehicle 202. The length of the first offset 220(1) is the distance at which the speed limit recited by the first speed limit sign 208(1) continuously applies in the first lane 207(1). FIG. 2B shows that, from the perspective of direction 204(1), the first offset 220(1) extends behind the first speed limit sign 208(1), meaning that the speed limit already applied to some distance of the first lane 207(1) prior to the location of the first speed limit sign 208(1). The first offset 220(1) also continues in front of the vehicle 202 for a distance between the first speed limit sign 208(1) and the yield sign 210, because the first speed limit sign 208(1) did not impose a different speed limit than that which applied to a section of the first lane 207(1) immediately preceding the location of the first speed limit sign 208(1) along direction 204(1). A perception system in the vehicle 202 already read the first speed limit sign 208(1), detected that the first speed limit sign 208(1) did not impose a different speed limit from the immediately preceding section of the first lane 207(1), and so the fusion component 116 continued to assign the first offset 220(1) for a distance beyond the first speed limit sign 208(1). In the example of FIG. 2B, the perception system of the vehicle 202, upon reading the yield sign 210, may provide data to other systems in vehicle 202 that cause vehicle 202 to begin slowing down to a speed below 35 MPH, despite that speed limit continuing to apply to the first lane 207(1) all the way up to the yield sign 210. The map information 200 may also provide such data to the vehicle 202 to cause the same or similar decrease in speed.

FIG. 2C is an is a diagram of the first environment 200(1) similar to FIG. 2B, except showing the vehicle 202 traveling in a second direction 204(2) on the second lane 207(2) of the second road 206(2). As shown, vehicle 202 is using its perception system to read the speed limit from the second speed limit sign 208(2), and is continuing to receive the map information 200 as additional speed limit data. The map information 200 and its transmission (arrow 203) to the vehicle 202 are discussed in greater detail with regard to FIG. 8D. The fusion component 116 has assigned two offsets to the portion of the second lane 207(2) shown in FIG. 2C, namely, a second offset 220(2) and a third offset 220(3). From the perspective of second direction 212(2), second offset 220(2) extends for a distance behind the second speed limit sign 208(2) (and behind the vehicle 202), because the section of the second lane 207(2) preceding the second speed limit sign 208(2) is governed by a speed limit other than 45 MPH. Then, once the perception system of the vehicle 202 reads, and/or the map information 200 informs of, a 45 MPH speed limit due to the second speed limit sign 208(2), another offset applies, namely the third offset 220(3), which extends in the direction 204(2) to a point outside of the environment 200(1).

FIG. 2D is a diagram of a second environment 200(2), in which the vehicle 202 is shown traveling in a third direction 204(3) on a third lane 207(3) of a third road 206(3). The third lane 207(3) is shown associated with a third speed limit sign 208(3) reciting a speed limit of 55 MPH, and with a zone sign 214 that is understood for illustrative purposes to require a slower speed than 55 MPH. The zone sign 214 shall be understood to be any sign that imposes a lower speed limit than that governing a portion of the lane of travel immediately prior to the zone sign 214. For example, the zone sign 214 may indicate the start of a school zone or of a road construction zone. The zone is understood to extend a predetermined distance along the third lane 207(3) to a termination point (not shown), where the higher speed limit that applied to the third lane immediately prior to the zone sign 214 resumes. In FIG. 2D, the vehicle 202 has already driven past the third speed limit sign 208(3). The vehicle 202 is shown using its perception system to read the zone sign 214, and it is continuing to receive additional speed limit data as map information 222 from its nav-map system. The map information 222 and its transmission (arrow 203) to the vehicle 202 are discussed in greater detail with regard to FIG. 8D. The fusion component 116 has assigned three offsets to the portion of the third lane 207(3) shown in FIG. 2D, namely, a fourth offset 220(4), a fifth offset 220(5), and a sixth offset 220(6). From the perspective of the third direction 212(3), the fourth offset 220(4) extends for a distance behind the third speed limit sign 208(3) (and behind the vehicle 202), because the section of the third lane 207(3) preceding the third speed limit sign 208(3) is governed by a speed limit other than 55 MPH. Then, once the perception system of the vehicle 202 reads, and/or the map information 222 informs of, a 55 MPH speed limit due to the third speed limit sign 208(3), another offset applies, namely the fifth offset 220(5), which extends in the direction 204(3) in front of the third speed limit sign 208(3) along that direction up to the location of zone sign 214. Then the fusion component 116 assigns a sixth offset for a distance equaling the distance of the zone demarcated by the zone sign 214.

While the example of FIGS. 2A-2D illustrate just a few examples of a vehicle fusing data in order to determine a speed limit, in other examples, the vehicle may use additional and/or alternative rules to fuse data in order to determine a speed limit, which are described in more detail herein.

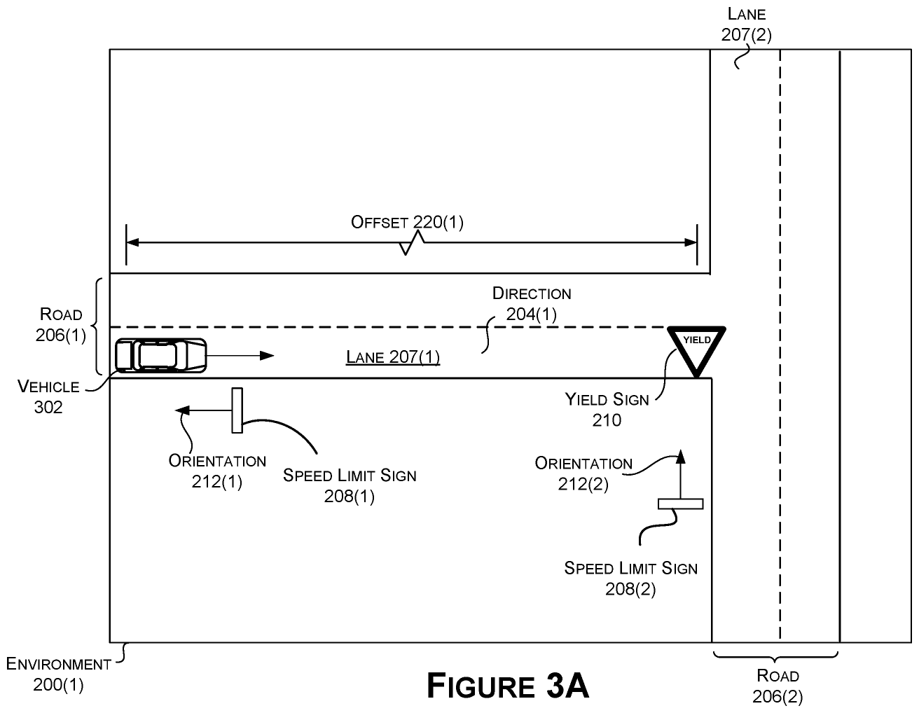

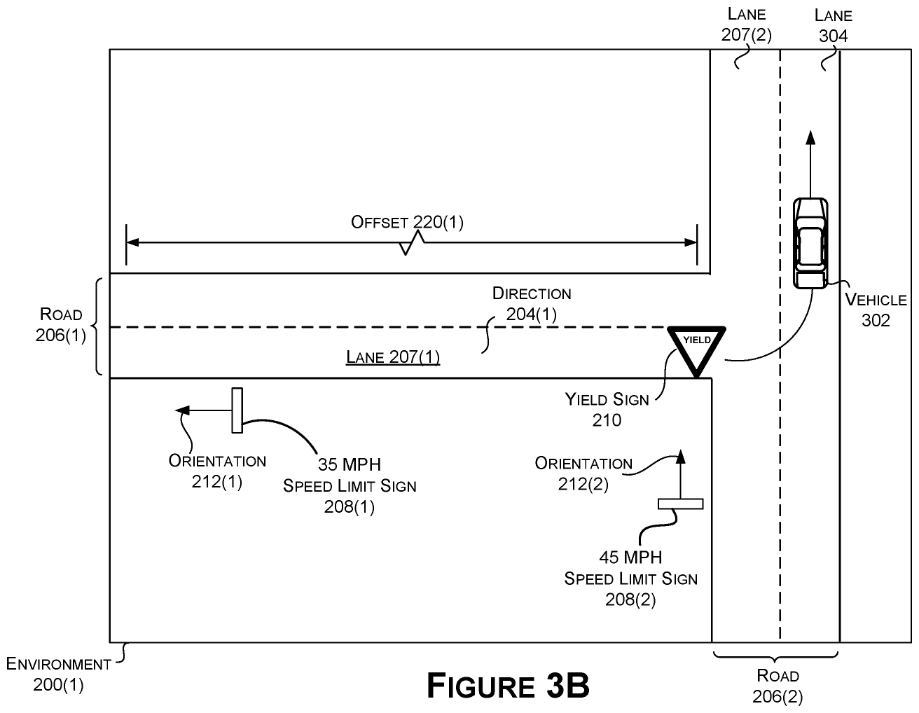

Now that the offsets have been discussed, FIGS. 3A-3B are examples of using one or more rules to fuse speed limit data from a perception system with speed limit data associated with a map, in accordance with some embodiments of the present disclosure. For instance, and as illustrated in the example of FIG. 3A, a vehicle 302 may be navigating along the first lane 207(1) and approaching the first speed limit sign 208(1). While navigating, the vehicle 302 may use one or more sensors (e.g., the sensor(s) 106) to generate sensor data (e.g., the sensor data 104) representing the first speed limit sign 208(1). The vehicle 302 may then process the sensor data using a perception system (e.g., the perception component 102) and, based at least on the processing, determine a first speed limit associated with the first speed limit sign 208(1) and/or a probability associated with the first speed limit. In some examples, the vehicle 302 may then associate the first speed limit with the first lane 207(1) for which the vehicle 202 is navigating.

The vehicle 302 may also use the map 200 of the environment 200(1) to determine a second speed limit associated with the first speed limit sign 208(1). For example, the vehicle 302 may use an additional portion of the sensor data, such as location data, to determine a pose associated with the vehicle 302 within the environment (described in more detail herein). The vehicle 302 may then determine, based at least on the pose, that the vehicle 302 is navigating along the first lane 207(1) within the environment 200(1). Additionally, the vehicle 302 may then determine, using the map 200, that the first speed limit sign 208(1) is associated with the first lane 207(1). Based at least on the determination, the vehicle 302 may further use the map 200 to determine that the second speed limit is associated with the first speed limit sign 208(1) and, as such, associated with the first lane 207(1).

The vehicle 302 (e.g., the fusion component 116) may then determine whether the first speed limit corresponds to (e.g., matches) the second speed limit. If the vehicle 302 determines that the first speed limit does correspond to the second speed limit, then the vehicle 302 may determine that the final speed limit includes the first speed limit and/or the second speed limit. However, if the vehicle 302 determines that the first speed limit does not correspond to (e.g., does not match) the second speed limit, then the vehicle 302 may determine whether the final speed limit includes the first speed limit or the second speed limit. For a first example, the vehicle 302 may determine that the final speed limit includes the first speed limit based at least on the probability satisfying the threshold probability, or the vehicle 302 may determine that the final speed limit includes the speed limit based at least on the probability not satisfying the threshold probability.

For a second example, the vehicle 302 may additionally, or alternatively, determine whether the age of the first speed limit satisfies the threshold age. In some examples, the vehicle 302 may make the determination using the offset 220(1) from the example of FIG. 2B. For example, the vehicle 202 may determine that the age satisfies the threshold age based at least on the vehicle 302 still navigating within an area associated with the offset 220(1). Based at least on that determination, the vehicle 302 may determine that the final speed limit includes the first speed limit.

Next, and with regard to the example of FIG. 3B, the vehicle 302 may turn onto a new lane 304. As such, the vehicle 302 may use the map 200 of the environment to determine a second speed limit associated with the new lane 304 (e.g., a speed limit sign associated with the new lane 304, which is not illustrated since the vehicle 302 has yet to approach the speed limit sign). For example, the vehicle 302 may use the sensor data, such as location data, to determine a pose associated with the vehicle 302 within the environment (described in more detail herein). The vehicle 302 may then determine, based at least on the pose, that the vehicle 302 is navigating along the new lane 304 within the environment. Additionally, the vehicle 302 may then determine, using the map 200, that the speed limit sign is associated with the new lane 304. Based at least on the determination, the vehicle 302 may further use the map 200 to determine that the second speed limit is associated with the speed limit sign and, as such, associated with the new lane 304.

However, since the vehicle 302 has not approached the speed limit sign in the example of FIG. 3B, the vehicle 302 may still be using the first speed limit associated with the first speed limit sign 208(1) as the perception speed limit. The vehicle 302 (e.g., the fusion component 116) may then determine whether the first speed limit corresponds to (e.g., matches) the second speed limit. If the vehicle 302 determines that the first speed limit does correspond to the second speed limit, then the vehicle 302 may determine that the final speed limit includes the first speed limit and/or the second speed limit. However, if the vehicle 302 determines that the first speed limit does not correspond to (e.g., does not match) the second speed limit, then the vehicle 302 may determine whether the final speed limit includes the first speed limit or the second speed limit.

For example, the vehicle 302 may determine that the vehicle 302 changed paths from navigating along the first lane 207(1) to navigating along the new lane 304 (e.g., the vehicle 302 has turned). Additionally, the vehicle 302 may determine that a new perception speed limit has not been determined since changing paths. Based at least on these determinations, the vehicle 302 may determine that the final speed limit includes the second speed limit.

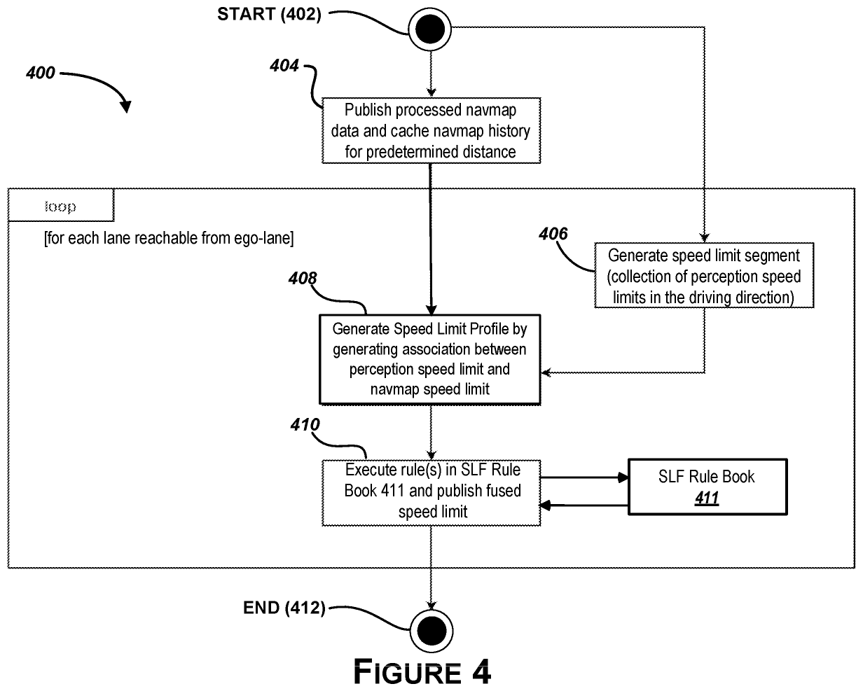

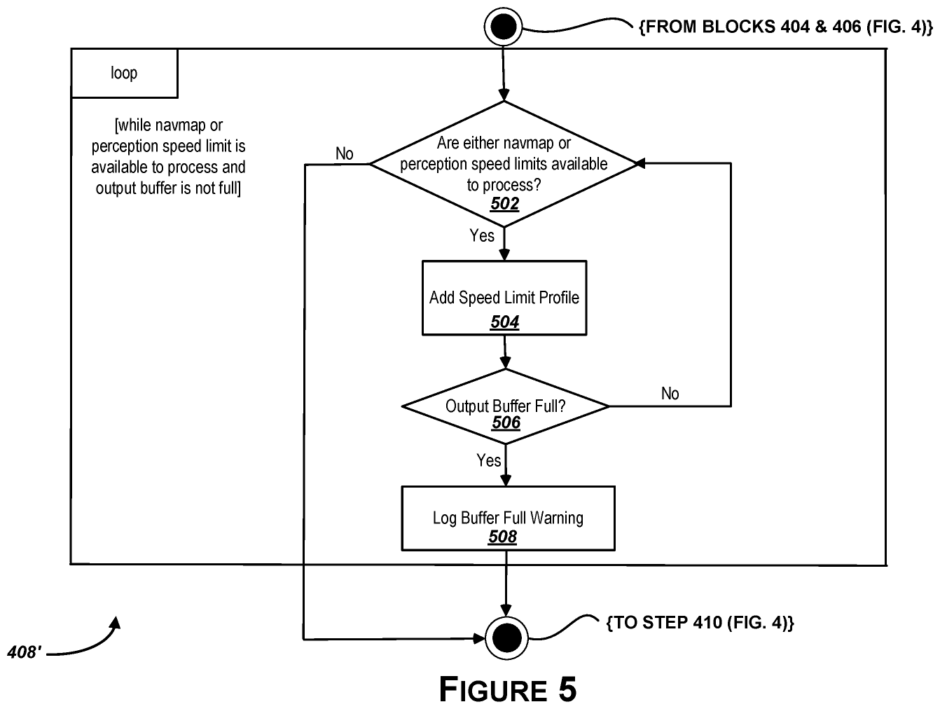

FIG. 4 illustrates an example of a fusion algorithm, in accordance with some embodiments of the present disclosure. Each block of method 400, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 400 is described, by way of example, with respect to the fusion component 116 of FIG. 1. However, these methods may additionally or alternatively be executed by any one system, or any combination of systems, including, but not limited to, those described herein.

The method 400 begins at start 402, which may be any occurrence that triggers the generation of the data described in blocks 406 and 408. Block 404 recites functions of a “nav-map tracker,” which may comprise, or be a portion of, the processing component 110 (FIG. 1). The nav-map tracker may (e.g., constantly) monitor a stream of the nav-map data/information 200 (FIGS. 2B-2D) being received by the vehicle 202 (FIGS. 2B-2D). At a predetermined frequency (such as 15 Hertz), the nav-map tracker may take snapshots of the nav-map data, each snapshot defining a nav-map data frame. The nav-map tracker caches historical nav-map data taken for a predetermined distance (such as 2000 meters (m)) behind the vehicle 202 as it travels in a lane. The nav-map tracker may then “publish” each nav-map data frame, together with the cached nav-map historical data corresponding to the data frame, to the fusion component 116 (FIG. 1). In some embodiments, the nav-map tracker may also pre-process the received nav-map data 200 before transmitting it to the fusion component 116. Such pre-processing may include converting the received nav-map data to a format more conducive to further processing, de-duplication of speed limit values, and removing outdated data. Appending cached nav-map speed limit data to a nav-map data frame allows the fusion component 116 to have a complete picture with which to make an informed decision when executing the methods described herein for choosing which speed limit value to publish as speed limit data 122 to the computing system(s) 124 (FIG. 1). Block 404 represents the only stateful portion of method 400, meaning that the operations represented by block 404 are the only ones in method 400 that are dependent on previously stored data. The stateful nature of block 404 allows the operations represented by the remaining blocks in method 400 to be stateless, meaning that they are independent of previously stored data. The stateless nature of those operations of method 400 makes it easier to debug the fusion component 116. Once the operations of block 404 are executed, method 400 progresses from block 404 to block 408. Since method 400 also progresses to block 408 from block 406, however, block 406 will be described before block 408.

At block 406, the method 400 generates speed limit segments for the lane of travel. At block 406, method 400 first collects perception speed limits in the driving direction, each perception speed limit already associated with an offset. Block 406 represents a preprocessing operation for perception speed limits. Perception speed limits are typically in a World Model (WM) format. WM encodes one or more (e.g., each of the) speed limits as its own independent entry. In block 406, method 400 converts the collected perception speed limits from WM format into a format that is more conducive for further processing. A perception speed limit preprocessed in this manner is called a “speed limit segment.” Additionally, any conditional speed limit that may apply to the same offset associated with a collected perception speed limit is also encoded into the same speed limit segment. Thus, a speed limit segment may be generated each time a value of a collected perception speed limit changes. From block 406, method 400 advances to block 408.

At block 408, the method 400 generates a “speed limit profile.” A speed limit profile is generated by further associating the offset, which is already associated with a perception speed limit collected at block 406, with a nav-map data frame published at block 404. Through their common association with the offset, the nav-map data frame from block 404 and the speed limit segment from block 406 can be associated with one another. The two types of speed limit data thereby associated with one another in a speed limit profile can be termed an associated speed limit segment and an associated nav-map MPP speed limit. The processing operations represented by block 408 will now be discussed in detail with reference to FIG. 5.

FIG. 5 is a flow chart illustrating a series of processing operations 408 represented by block 408 in FIG. 4, in accordance with some embodiments of the present disclosure. Series 408 begins at block 502, where series 408 determines whether either a nav-map speed limit or a perception speed limit is available to process. If there are none, then series 408 advances directly to step 410 of FIG. 4, described later below. If, however, such speed limit data exists, then a speed limit profile is generated in the manner described above, and series 408 advances to block 504, where the generated speed limit profile is added (stored) into an output buffer, which is a block of memory in a memory unit operatively communicating with the fusion component 116 (FIG. 1). A list of speed limit profiles are stored in the output buffer because the vehicle 202 (FIGS. 2B-2D) is subject to a variety of different speed limits over different distances along a direction of travel. After such storage of the generated speed limit profile, series 408 advances to block 506, where it is determined whether the output buffer is full. If not, then series 408 loops back to block 502; if so, then series 408 advances to block 508, where a “buffer full” warning is logged. From block 508, series 408 advances to operation 410 of FIG. 4, described below.

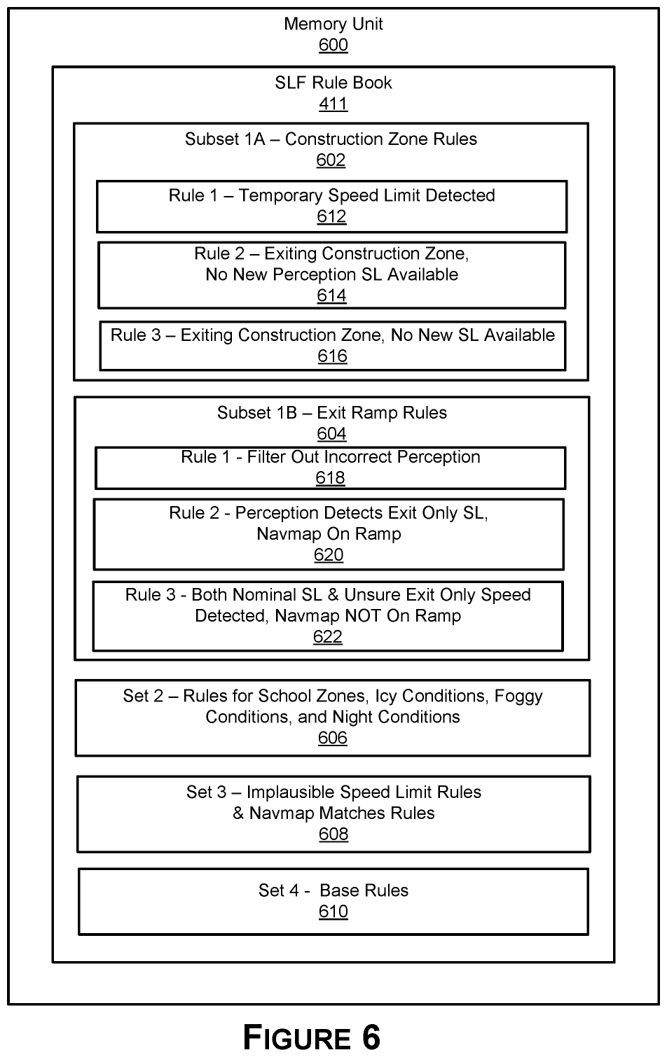

Referring once again to FIG. 4, following execution of the operations described above with regard to FIG. 5, method 400 advances from block 408 to block 410. For each speed limit profile stored into the output buffer, method 400 at block 410 selects which speed limit to publish, as between a perception speed limit in the associated speed limit segment on one hand, and the associated nav-map MPP speed limit in the profile on the other. This determination is done by executing one of a plurality of rules selected from an SLF rule book 411, described in further detail below with regard to FIG. 6. Following execution of the selected rule, method 400 advances from block 410 to the end 412, which may represent the operation of at which the resulting speed limit data 122 is published to the computing system(s) 124 (FIG. 1).

FIG. 6 is block diagram representing an example SLF rule book 411 electronically stored in a memory unit 600, in accordance with some embodiments of the present disclosure. The SLF rule book 411 comprises a plurality of stored instructions (rules), each rule instructing the fusion component 116 (FIG. 1) to, for each stored speed limit profile, publish either a perception speed limit in the associated speed limit segment of the profile, or an associated nav-map MPP speed limit in the same profile. Each rule addresses a condition, or set of conditions, existing at the time that the fusion component 116 is to execute a rule. In some embodiments, the rules of the SLF rule book 411 can be organized into groups, or sets. For example, as illustrated in FIG. 6, the rules may be organized into four sets: set 1, comprising a subset 1A (602) of construction zone rules and a subset 1B (604) of exit ramp rules; set 2 (606), comprising rules for school zones, icy conditions, foggy conditions, and night conditions; set 3 (608), comprising implausible speed limit rules and nav-map matches rules; and set 4 (610), comprising base rules. For purposes of illustration, FIG. 6 shows subset 1A (602) containing three rules 612,614,616 and subset 1B (604) containing three rules 618,620,622. It is to be understood that the remaining sets 606,608,610 likewise each contain a plurality of additional respective rules, though such rules have been omitted from FIG. 6 for ease of illustration. In some embodiments, the sets 602,604,606,608,610 are arranged in priority order, namely, in the order of specificity of conditions, such that the last set 610 contains base rules that may only apply if existing conditions do not match any of the rules in the preceding sets 602,604,606,608. Rules within a set are likewise listed in priority order. The first-listed rule in any of the sets to match conditions associated with a speed limit profile is executed, and the fusion component 116 (FIG. 1) publishes the speed limit data 122 accordingly. Examples of rules comprising the SLF rule book 411 will now be described, first with reference to subset 602, directed to construction zone rules, and then with reference to subset 604, directed to school zone rules.

In subset 602, construction zone rule 612 instructs the fusion component 116 (FIG. 1) to publish the perception speed limit in the speed limit profile if the sensor(s) 106 (FIG. 1) detect a temporary speed limit; construction zone rule 614 instructs the fusion component 116 to publish the nav-map speed limit in the speed limit profile if the vehicle 202 is exiting a construction zone and the speed limit profile does not include a perception speed limit (“SL” in FIG. 6); and construction zone rule 616 instructs the fusion component 116 to publish a cached nav-map speed limit in the speed limit profile if the vehicle 202 is exiting a construction zone and the speed limit profile does not include either a new perception speed limit or a new nav-map speed limit.

In subset 604, exit ramp rule 618 addresses a condition in which the perception speed limit in a speed limit profile and a nav-map speed limit in that same speed limit profile do not match. Such a condition can arise where, for example, one or more perception speed limit sensors incorrectly interpret an exit-only speed limit as a nominal speed limit. Other situations can cause such a mismatch between the perception speed limit and the nav-map speed limit. Exit ramp rule 618 is designed to filter out incorrectly detected perception speed limits in the event of such a speed limit mismatch by instructing the perception component 102 and processing component 110 (FIG. 1) to search for a new speed limit from a nearby alternate path that has either matching speed limits or just a nav-map speed limit. If such an alternate path is found, the perception speed limit of the speed limit profile is discarded, and the exit ramp rule 618 instructs the fusion component 116 to publish the nav-map speed limit associated with the located alternate path. The second exit ramp rule in subset 604, namely exit ramp rule 620, addresses a condition in which the perception component 102 detects an exit only speed limit marked as “relevant unsure,” and location for the nav-map speed limit is the exit ramp. In that situation, exit ramp rule 620 instructs the fusion component 116 to publish the perception speed limit in the speed limit profile. In the embodiment exemplified in FIG. 6, exit ramp rule 622 appears as the final rule of subset 604. Exit ramp rule 622 exemplifies a result in which the fusion component 116 publishes two separate speed limits instead of just one. Exit ramp rule 622 addresses conditions in which: (i) the perception component 102 detects both a nominal perception speed limit and an “unsure” exit only perception speed limit; and (ii) the map position associated with the nav-map speed limit is NOT on the exit ramp on which the vehicle 202 is traveling. Given those conditions, exit ramp rule 622 instructs the fusion component 116 to publish both of the perception speed limits in the speed limit profile. The nominal perception speed limit is published under an “index 0” as “relevant,” and the exit only speed limit is published under an “index 1” as “unsure relevant.” When the fusion component 116 publishes two speed limits, the driver of the vehicle may make a decision as to which speed limit applies, given the designations appended to each of the published perception speed limits and/or the fusion component 116 may select between one of the speed limit signs, using any of the techniques described herein. Exit ramp rule 622 is not the only rule in the SLF rule book 411 that calls for the publication of two speed limits; such a result can occur responsive to execution of many other rules in the SLF rule book 411.

Other rules in the SLF rule book 411 need not rely solely on data appearing in a speed limit profile. Such rules may also obtain condition information from additional sources. For instance, the icy condition rules in set 606 may also analyze data transmitted by an operational design domain (ODD) monitor, which may reside among the sensor(s) 106 of FIG. 1. The ODD monitor can assess outdoor conditions such as whether a lane or local weather indicate icy conditions. Thus, for example, one of the rules in set 606 can specify that if the ODD monitor detects that the environment is icy and the speed limit profile contains only a nav-map icy speed limit, then the fusion component 116 will publish the nav-map icy speed limit.

As an example of a base rule residing in set 610, a rule can simply direct the fusion component 116 to publish a perception speed limit in a speed limit profile if the perception speed limit is valid. A perception speed limit change may be deemed valid if the offset associated with it is within a distance threshold corresponding to a nav-map speed limit change. In such a condition, confidence of the perception speed limit is high.

In some embodiments, the rules of SLF rule book 411 can be expressed in a structured protobuf schema, and a given rule set can be expressed as a TEXTPROTO file that contains rule definitions for each rule that is to reside in that set. These formats facilitate rule definition and modification and promote set modularity. However, the foregoing format description is exemplary and not intended to be limiting. Similarly, the number of rules illustrated in FIG. 6 as residing within subsets 602,604 need not be limited to three each. Additional rules may reside in each of those sets as necessary.

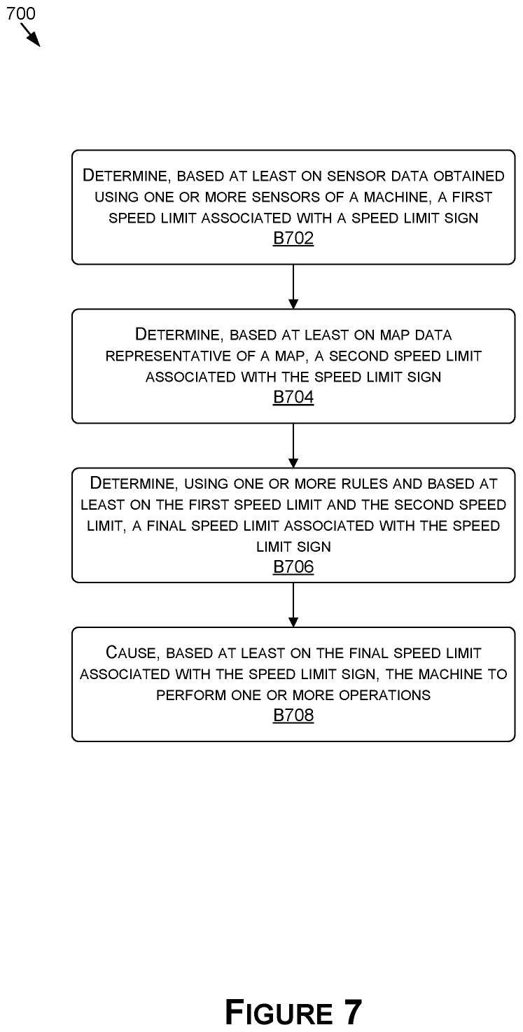

Now referring to FIG. 7, each block of method 700, described herein, comprises a computing process that may be performed using any combination of hardware, firmware, and/or software. For instance, various functions may be carried out by a processor executing instructions stored in memory. The method 700 may also be embodied as computer-usable instructions stored on computer storage media. The method 700 may be provided by a standalone application, a service or hosted service (standalone or in combination with another hosted service), or a plug-in to another product, to name a few. In addition, the method 700 is described, by way of example, with respect to FIG. 1. However, the method 700 may additionally or alternatively be executed by any one system, or any combination of systems, including, but not limited to, those described herein.

The method 700, at block B702, may include determining, based at least on sensor data obtained using one or more sensors of a machine, a first speed limit associated with a speed limit sign. For instance, the perception component 102 (e.g., a perception system) may receive the sensor data 104 generated using the sensor(s) 106. As described herein, the sensor data 106 may include, but is not limited to, image data, video data, LiDAR data, RADAR data, and/or any other type of sensor data. Additionally, the sensor data 104 may represent a sensor representation (e.g., an image) depicting a speed limit sign. The perception component 102 may then process the sensor data 104 and, based at least on the processing, determine the first speed limit associated with the speed limit sign.

The method 700, at block B704, may include determining, based at least on map data, a second speed limit associated with the speed limit sign. For instance, the processing component 110 may receive the sensor data 104 generated using the sensor(s) 106. As described herein, this sensor data 104 may include, but is not limited to, location data, image data, video data, LiDAR data, RADAR data, and/or any other type of data. The processing component 110 may then process the sensor data 104 and, based at least on the processing, determine a location of the machine within the environment. Additionally, the processing component 110 may use the location to localize the machine on a map represented by the map data 112. The processing component 110 may then use the map to determine the second speed limit associated with the speed limit sign.

The method 700, at block B706, may include determining, using one or more rules and based at least on the first speed limit and the second speed limit, a final speed limit associated with the speed limit sign. For instance, the fusion component 116 may use the first speed limit, the second speed limit, and the rule(s) to determine the final speed limit associated with the speed limit sign. As described herein, a rule may indicate that if the first speed limit matches the second speed limit, then the final speed limit includes the first speed limit and/or the second speed limit. Additionally, a rule may indicate that if the first speed limit does not match the second speed limit, then the final speed limit includes one of the first speed limit or the second speed limit. Using techniques to determine whether the final speed limit includes the first speed limit or the second speed limit is described in more detail with regard to FIGS. 1-6.

The method 700, at block B708, may include causing, based at least on the final speed limit sign, the machine to perform one or more operations. For instance, the computing system(s) 102 may use the final speed limit, which may be represented by the speed limit data 122, to cause the machine to perform the operation(s), such navigating according to the final speed limit.

### Example Autonomous Vehicle

FIG. 8A is an illustration of an example autonomous vehicle 800, in accordance with some embodiments of the present disclosure. The autonomous vehicle 800 (alternatively referred to herein as the “vehicle 800”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 800 may be capable of functionality in accordance with one or more of Level 3-Level 5 of the autonomous driving levels. The vehicle 800 may be capable of functionality in accordance with one or more of Level 1-Level 5 of the autonomous driving levels. For example, the vehicle 800 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 800 or other machine, such as being fully autonomous, being highly autonomous, being conditionally autonomous, being partially autonomous, providing assistive autonomy, being semi-autonomous, being primarily autonomous, or other designation.

The vehicle 800 may include components such as a chassis, a vehicle body, wheels (e.g., 2, 4, 6, 8, 18, etc.), tires, axles, and other components of a vehicle. The vehicle 800 may include a propulsion system 850, such as an internal combustion engine, hybrid electric power plant, an all-electric engine, and/or another propulsion system type. The propulsion system 850 may be connected to a drive train of the vehicle 800, which may include a transmission, to enable the propulsion of the vehicle 800. The propulsion system 850 may be controlled in response to receiving signals from the throttle/accelerator 852.

A steering system 854, which may include a steering wheel, may be used to steer the vehicle 800 (e.g., along a desired path or route) when the propulsion system 850 is operating (e.g., when the vehicle is in motion). The steering system 854 may receive signals from a steering actuator 856. The steering wheel may be optional for full automation (Level 5) functionality.

The brake sensor system 846 may be used to operate the vehicle brakes in response to receiving signals from the brake actuators 848 and/or brake sensors.

Controller(s) 836, which may include one or more system on chips (SoCs) 804 (FIG. 8C) and/or GPU(s), may provide signals (e.g., representative of commands) to one or more components and/or systems of the vehicle 800. For example, the controller(s) may send signals to operate the vehicle brakes via one or more brake actuators 848, to operate the steering system 854 via one or more steering actuators 856, to operate the propulsion system 850 via one or more throttle/accelerators 852. The controller(s) 836 may include one or more onboard (e.g., integrated) computing devices (e.g., supercomputers) that process sensor signals, and output operation commands (e.g., signals representing commands) to enable autonomous driving and/or to assist a human driver in driving the vehicle 800. The controller(s) 836 may include a first controller 836 for autonomous driving functions, a second controller 836 for functional safety functions, a third controller 836 for artificial intelligence functionality (e.g., computer vision), a fourth controller 836 for infotainment functionality, a fifth controller 836 for redundancy in emergency conditions, and/or other controllers. In some examples, a single controller 836 may handle two or more of the above functionalities, two or more controllers 836 may handle a single functionality, and/or any combination thereof.

The controller(s) 836 may provide the signals for controlling one or more components and/or systems of the vehicle 800 in response to sensor data received from one or more sensors (e.g., sensor inputs). The sensor data may be received from, for example and without limitation, global navigation satellite systems (“GNSS”) sensor(s) 858 (e.g., Global Positioning System sensor(s)), RADAR sensor(s) 860, ultrasonic sensor(s) 862, LIDAR sensor(s) 864, inertial measurement unit (IMU) sensor(s) 866 (e.g., accelerometer(s), gyroscope(s), magnetic compass(es), magnetometer(s), etc.), microphone(s) 896, stereo camera(s) 868, wide-view camera(s) 870 (e.g., fisheye cameras), infrared camera(s) 872, surround camera(s) 874 (e.g., 360 degree cameras), long-range and/or mid-range camera(s) 898, speed sensor(s) 844 (e.g., for measuring the speed of the vehicle 800), vibration sensor(s) 842, steering sensor(s) 840, brake sensor(s) (e.g., as part of the brake sensor system 846), and/or other sensor types.

One or more of the controller(s) 836 may receive inputs (e.g., represented by input data) from an instrument cluster 832 of the vehicle 800 and provide outputs (e.g., represented by output data, display data, etc.) via a human-machine interface (HMI) display 834, an audible annunciator, a loudspeaker, and/or via other components of the vehicle 800. The outputs may include information such as vehicle velocity, speed, time, map data (e.g., the High Definition (“HD”) map 822 of FIG. 8C), location data (e.g., the vehicle's 800 location, such as on a map), direction, location of other vehicles (e.g., an occupancy grid), information about objects and status of objects as perceived by the controller(s) 836, etc. For example, the HMI display 834 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 800 further includes a network interface 824 which may use one or more wireless antenna(s) 826 and/or modem(s) to communicate over one or more networks. For example, the network interface 824 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 826 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 8B is an example of camera locations and fields of view for the example autonomous vehicle 800 of FIG. 8A, in accordance with some embodiments of the present disclosure. The cameras and respective fields of view are one example embodiment and are not intended to be limiting. For example, additional and/or alternative cameras may be included and/or the cameras may be located at different locations on the vehicle 800.

The camera types for the cameras may include, but are not limited to, digital cameras that may be adapted for use with the components and/or systems of the vehicle 800. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 800 (e.g., front-facing cameras) may be used for surround view, to help identify forward facing paths and obstacles, as well aid in, with the help of one or more controllers 836 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 870 that may be used to perceive objects coming into view from the periphery (e.g., pedestrians, crossing traffic or bicycles). Although only one wide-view camera is illustrated in FIG. 8B, there may be any number (including zero) of wide-view cameras 870 on the vehicle 800. In addition, any number of long-range camera(s) 898 (e.g., a long-view stereo camera pair) may be used for depth-based object detection, especially for objects for which a neural network has not yet been trained. The long-range camera(s) 898 may also be used for object detection and classification, as well as basic object tracking.

Any number of stereo cameras 868 may also be included in a front-facing configuration. In at least one embodiment, one or more of stereo camera(s) 868 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 868 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 868 may be used in addition to, or alternatively from, those described herein.

Cameras with a field of view that include portions of the environment to the side of the vehicle 800 (e.g., side-view cameras) may be used for surround view, providing information used to create and update the occupancy grid, as well as to generate side impact collision warnings. For example, surround camera(s) 874 (e.g., four surround cameras 874 as illustrated in FIG. 8B) may be positioned to on the vehicle 800. The surround camera(s) 874 may include wide-view camera(s) 870, fisheye camera(s), 360 degree camera(s), and/or the like. Four example, four fisheye cameras may be positioned on the vehicle's front, rear, and sides. In an alternative arrangement, the vehicle may use three surround camera(s) 874 (e.g., left, right, and rear), and may leverage one or more other camera(s) (e.g., a forward-facing camera) as a fourth surround view camera.

Cameras with a field of view that include portions of the environment to the rear of the vehicle 800 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 898, stereo camera(s) 868), infrared camera(s) 872, etc.), as described herein.

FIG. 8C is a block diagram of an example system architecture for the example autonomous vehicle 800 of FIG. 8A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 800 in FIG. 8C are illustrated as being connected via bus 802. The bus 802 may include a Controller Area Network (CAN) data interface (alternatively referred to herein as a “CAN bus”). A CAN may be a network inside the vehicle 800 used to aid in control of various features and functionality of the vehicle 800, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 802 is described herein as being a CAN bus, this is not intended to be limiting. For example, in addition to, or alternatively from, the CAN bus, FlexRay and/or Ethernet may be used. Additionally, although a single line is used to represent the bus 802, this is not intended to be limiting. For example, there may be any number of busses 802, which may include one or more CAN busses, one or more FlexRay busses, one or more Ethernet busses, and/or one or more other types of busses using a different protocol. In some examples, two or more busses 802 may be used to perform different functions, and/or may be used for redundancy. For example, a first bus 802 may be used for collision avoidance functionality and a second bus 802 may be used for actuation control. In any example, each bus 802 may communicate with any of the components of the vehicle 800, and two or more busses 802 may communicate with the same components. In some examples, each SoC 804, each controller 836, and/or each computer within the vehicle may have access to the same input data (e.g., inputs from sensors of the vehicle 800), and may be connected to a common bus, such the CAN bus.

The vehicle 800 may include one or more controller(s) 836, such as those described herein with respect to FIG. 8A. The controller(s) 836 may be used for a variety of functions. The controller(s) 836 may be coupled to any of the various other components and systems of the vehicle 800, and may be used for control of the vehicle 800, artificial intelligence of the vehicle 800, infotainment for the vehicle 800, and/or the like.

The vehicle 800 may include a system(s) on a chip (SoC) 804. The SoC 804 may include CPU(s) 806, GPU(s) 808, processor(s) 810, cache(s) 812, accelerator(s) 814, data store(s) 816, and/or other components and features not illustrated. The SoC(s) 804 may be used to control the vehicle 800 in a variety of platforms and systems. For example, the SoC(s) 804 may be combined in a system (e.g., the system of the vehicle 800) with an HD map 822 which may obtain map refreshes and/or updates via a network interface 824 from one or more servers (e.g., server(s) 878 of FIG. 8D).

The CPU(s) 806 may include a CPU cluster or CPU complex (alternatively referred to herein as a “CCPLEX”). The CPU(s) 806 may include multiple cores and/or L2 caches. For example, in some embodiments, the CPU(s) 806 may include eight cores in a coherent multi-processor configuration. In some embodiments, the CPU(s) 806 may include four dual-core clusters where each cluster has a dedicated L2 cache (e.g., a 2 MB L2 cache). The CPU(s) 806 (e.g., the CCPLEX) may be configured to support simultaneous cluster operation enabling any combination of the clusters of the CPU(s) 806 to be active at any given time.

The CPU(s) 806 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 806 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 808 may include an integrated GPU (alternatively referred to herein as an “iGPU”). The GPU(s) 808 may be programmable and may be efficient for parallel workloads. The GPU(s) 808, in some examples, may use an enhanced tensor instruction set. The GPU(s) 808 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 808 may include at least eight streaming microprocessors. The GPU(s) 808 may use compute application programming interface(s) (API(s)). In addition, the GPU(s) 808 may use one or more parallel computing platforms and/or programming models (e.g., NVIDIA's CUDA).

The GPU(s) 808 may be power-optimized for best performance in automotive and embedded use cases. For example, the GPU(s) 808 may be fabricated on a Fin field-effect transistor (FinFET). However, this is not intended to be limiting and the GPU(s) 808 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 808 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 808 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 808 to access the CPU(s) 806 page tables directly. In such examples, when the GPU(s) 808 memory management unit (MMU) experiences a miss, an address translation request may be transmitted to the CPU(s) 806. In response, the CPU(s) 806 may look in its page tables for the virtual-to-physical mapping for the address and transmits the translation back to the GPU(s) 808. As such, unified memory technology may allow a single unified virtual address space for memory of both the CPU(s) 806 and the GPU(s) 808, thereby simplifying the GPU(s) 808 programming and porting of applications to the GPU(s) 808.

In addition, the GPU(s) 808 may include an access counter that may keep track of the frequency of access of the GPU(s) 808 to memory of other processors. The access counter may help ensure that memory pages are moved to the physical memory of the processor that is accessing the pages most frequently.

The SoC(s) 804 may include any number of cache(s) 812, including those described herein. For example, the cache(s) 812 may include an L3 cache that is available to both the CPU(s) 806 and the GPU(s) 808 (e.g., that is connected both the CPU(s) 806 and the GPU(s) 808). The cache(s) 812 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 804 may include an arithmetic logic unit(s) (ALU(s)) which may be leveraged in performing processing with respect to any of the variety of tasks or operations of the vehicle 800—such as processing DNNs. In addition, the SoC(s) 804 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 806 and/or GPU(s) 808.

The SoC(s) 804 may include one or more accelerators 814 (e.g., hardware accelerators, software accelerators, or a combination thereof). For example, the SoC(s) 804 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 808 and to off-load some of the tasks of the GPU(s) 808 (e.g., to free up more cycles of the GPU(s) 808 for performing other tasks). As an example, the accelerator(s) 814 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 814 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 808, and by using an inference accelerator, for example, a designer may target either the DLA(s) or the GPU(s) 808 for any function. For example, the designer may focus processing of CNNs and floating point operations on the DLA(s) and leave other functions to the GPU(s) 808 and/or other accelerator(s) 814.

The accelerator(s) 814 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 806. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 814 (e.g., the hardware acceleration cluster) may include a computer vision network on-chip and SRAM, for providing a high-bandwidth, low latency SRAM for the accelerator(s) 814. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 804 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 814 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 866 output that correlates with the vehicle 800 orientation, distance, 3D location estimates of the object obtained from the neural network and/or other sensors (e.g., LIDAR sensor(s) 864 or RADAR sensor(s) 860), among others.

The SoC(s) 804 may include data store(s) 816 (e.g., memory). The data store(s) 816 may be on-chip memory of the SoC(s) 804, which may store neural networks to be executed on the GPU and/or the DLA. In some examples, the data store(s) 816 may be large enough in capacity to store multiple instances of neural networks for redundancy and safety. The data store(s) 812 may comprise L2 or L3 cache(s) 812. Reference to the data store(s) 816 may include reference to the memory associated with the PVA, DLA, and/or other accelerator(s) 814, as described herein.

The SoC(s) 804 may include one or more processor(s) 810 (e.g., embedded processors). The processor(s) 810 may include a boot and power management processor that may be a dedicated processor and subsystem to handle boot power and management functions and related security enforcement. The boot and power management processor may be a part of the SoC(s) 804 boot sequence and may provide runtime power management services. The boot power and management processor may provide clock and voltage programming, assistance in system low power state transitions, management of SoC(s) 804 thermals and temperature sensors, and/or management of the SoC(s) 804 power states. Each temperature sensor may be implemented as a ring-oscillator whose output frequency is proportional to temperature, and the SoC(s) 804 may use the ring-oscillators to detect temperatures of the CPU(s) 806, GPU(s) 808, and/or accelerator(s) 814. If temperatures are determined to exceed a threshold, the boot and power management processor may enter a temperature fault routine and put the SoC(s) 804 into a lower power state and/or put the vehicle 800 into a chauffeur to safe stop mode (e.g., bring the vehicle 800 to a safe stop).

The processor(s) 810 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 810 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 810 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 810 may further include a real-time camera engine that may include a dedicated processor subsystem for handling real-time camera management.

The processor(s) 810 may further include a high-dynamic range signal processor that may include an image signal processor that is a hardware engine that is part of the camera processing pipeline.

The processor(s) 810 may include a video image compositor that may be a processing block (e.g., implemented on a microprocessor) that implements video post-processing functions needed by a video playback application to produce the final image for the player window. The video image compositor may perform lens distortion correction on wide-view camera(s) 870, surround camera(s) 874, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 808 is not required to continuously render new surfaces. Even when the GPU(s) 808 is powered on and active doing 3D rendering, the video image compositor may be used to offload the GPU(s) 808 to improve performance and responsiveness.

The SoC(s) 804 may further include a mobile industry processor interface (MIPI) camera serial interface for receiving video and input from cameras, a high-speed interface, and/or a video input block that may be used for camera and related pixel input functions. The SoC(s) 804 may further include an input/output controller(s) that may be controlled by software and may be used for receiving I/O signals that are uncommitted to a specific role.

The SoC(s) 804 may further include a broad range of peripheral interfaces to enable communication with peripherals, audio codecs, power management, and/or other devices. The SoC(s) 804 may be used to process data from cameras (e.g., connected over Gigabit Multimedia Serial Link and Ethernet), sensors (e.g., LIDAR sensor(s) 864, RADAR sensor(s) 860, etc. that may be connected over Ethernet), data from bus 802 (e.g., speed of vehicle 800, steering wheel position, etc.), data from GNSS sensor(s) 858 (e.g., connected over Ethernet or CAN bus). The SoC(s) 804 may further include dedicated high-performance mass storage controllers that may include their own DMA engines, and that may be used to free the CPU(s) 806 from routine data management tasks.

The SoC(s) 804 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 804 may be faster, more reliable, and even more energy-efficient and space-efficient than conventional systems. For example, the accelerator(s) 814, when combined with the CPU(s) 806, the GPU(s) 808, and the data store(s) 816, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 820) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 808.

In some examples, a CNN for facial recognition and vehicle owner identification may use data from camera sensors to identify the presence of an authorized driver and/or owner of the vehicle 800. The always on sensor processing engine may be used to unlock the vehicle when the owner approaches the driver door and turn on the lights, and, in security mode, to disable the vehicle when the owner leaves the vehicle. In this way, the SoC(s) 804 provide for security against theft and/or carjacking.

In another example, a CNN for emergency vehicle detection and identification may use data from microphones 896 to detect and identify emergency vehicle sirens. In contrast to conventional systems, that use general classifiers to detect sirens and manually extract features, the SoC(s) 804 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 858. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 862, until the emergency vehicle(s) passes.

The vehicle may include a CPU(s) 818 (e.g., discrete CPU(s), or dCPU(s)), that may be coupled to the SoC(s) 804 via a high-speed interconnect (e.g., PCIe). The CPU(s) 818 may include an X86 processor, for example. The CPU(s) 818 may be used to perform any of a variety of functions, including arbitrating potentially inconsistent results between ADAS sensors and the SoC(s) 804, and/or monitoring the status and health of the controller(s) 836 and/or infotainment SoC 830, for example.

The vehicle 800 may include a GPU(s) 820 (e.g., discrete GPU(s), or dGPU(s)), that may be coupled to the SoC(s) 804 via a high-speed interconnect (e.g., NVIDIA's NVLINK). The GPU(s) 820 may provide additional artificial intelligence functionality, such as by executing redundant and/or different neural networks, and may be used to train and/or update neural networks based on input (e.g., sensor data) from sensors of the vehicle 800.

The vehicle 800 may further include the network interface 824 which may include one or more wireless antennas 826 (e.g., one or more wireless antennas for different communication protocols, such as a cellular antenna, a Bluetooth antenna, etc.). The network interface 824 may be used to enable wireless connectivity over the Internet with the cloud (e.g., with the server(s) 878 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 800 information about vehicles in proximity to the vehicle 800 (e.g., vehicles in front of, on the side of, and/or behind the vehicle 800). This functionality may be part of a cooperative adaptive cruise control functionality of the vehicle 800.

The network interface 824 may include a SoC that provides modulation and demodulation functionality and enables the controller(s) 836 to communicate over wireless networks. The network interface 824 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 800 may further include data store(s) 828 which may include off-chip (e.g., off the SoC(s) 804) storage. The data store(s) 828 may include one or more storage elements including RAM, SRAM, DRAM, VRAM, Flash, hard disks, and/or other components and/or devices that may store at least one bit of data.

The vehicle 800 may further include GNSS sensor(s) 858. The GNSS sensor(s) 858 (e.g., GPS, assisted GPS sensors, differential GPS (DGPS) sensors, etc.), to assist in mapping, perception, occupancy grid generation, and/or path planning functions. Any number of GNSS sensor(s) 858 may be used, including, for example and without limitation, a GPS using a USB connector with an Ethernet to Serial (RS-232) bridge.

The vehicle 800 may further include RADAR sensor(s) 860. The RADAR sensor(s) 860 may be used by the vehicle 800 for long-range vehicle detection, even in darkness and/or severe weather conditions. RADAR functional safety levels may be ASIL B. The RADAR sensor(s) 860 may use the CAN and/or the bus 802 (e.g., to transmit data generated by the RADAR sensor(s) 860) for control and to access object tracking data, with access to Ethernet to access raw data in some examples. A wide variety of RADAR sensor types may be used. For example, and without limitation, the RADAR sensor(s) 860 may be suitable for front, rear, and side RADAR use. In some example, Pulse Doppler RADAR sensor(s) are used.

The RADAR sensor(s) 860 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 860 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 800 surroundings at higher speeds with minimal interference from traffic in adjacent lanes. The other two antennae may expand the field of view, making it possible to quickly detect vehicles entering or leaving the vehicle's 800 lane.

Mid-range RADAR systems may include, as an example, a range of up to 860 m (front) or 80 m (rear), and a field of view of up to 42 degrees (front) or 850 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 800 may further include ultrasonic sensor(s) 862. The ultrasonic sensor(s) 862, which may be positioned at the front, back, and/or the sides of the vehicle 800, may be used for park assist and/or to create and update an occupancy grid. A wide variety of ultrasonic sensor(s) 862 may be used, and different ultrasonic sensor(s) 862 may be used for different ranges of detection (e.g., 2.5 m, 4 m). The ultrasonic sensor(s) 862 may operate at functional safety levels of ASIL B.

The vehicle 800 may include LIDAR sensor(s) 864. The LIDAR sensor(s) 864 may be used for object and pedestrian detection, emergency braking, collision avoidance, and/or other functions. The LIDAR sensor(s) 864 may be functional safety level ASIL B. In some examples, the vehicle 800 may include multiple LIDAR sensors 864 (e.g., two, four, six, etc.) that may use Ethernet (e.g., to provide data to a Gigabit Ethernet switch).

In some examples, the LIDAR sensor(s) 864 may be capable of providing a list of objects and their distances for a 360-degree field of view. Commercially available LIDAR sensor(s) 864 may have an advertised range of approximately 800 m, with an accuracy of 2 cm-3 cm, and with support for a 800 Mbps Ethernet connection, for example. In some examples, one or more non-protruding LIDAR sensors 864 may be used. In such examples, the LIDAR sensor(s) 864 may be implemented as a small device that may be embedded into the front, rear, sides, and/or corners of the vehicle 800. The LIDAR sensor(s) 864, in such examples, may provide up to a 120-degree horizontal and 35-degree vertical field-of-view, with a 200 m range even for low-reflectivity objects. Front-mounted LIDAR sensor(s) 864 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 800. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 864 may be less susceptible to motion blur, vibration, and/or shock.

The vehicle may further include IMU sensor(s) 866. The IMU sensor(s) 866 may be located at a center of the rear axle of the vehicle 800, in some examples. The IMU sensor(s) 866 may include, for example and without limitation, an accelerometer(s), a magnetometer(s), a gyroscope(s), a magnetic compass(es), and/or other sensor types. In some examples, such as in six-axis applications, the IMU sensor(s) 866 may include accelerometers and gyroscopes, while in nine-axis applications, the IMU sensor(s) 866 may include accelerometers, gyroscopes, and magnetometers.

In some embodiments, the IMU sensor(s) 866 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 866 may enable the vehicle 800 to estimate heading without requiring input from a magnetic sensor by directly observing and correlating the changes in velocity from GPS to the IMU sensor(s) 866. In some examples, the IMU sensor(s) 866 and the GNSS sensor(s) 858 may be combined in a single integrated unit.

The vehicle may include microphone(s) 896 placed in and/or around the vehicle 800. The microphone(s) 896 may be used for emergency vehicle detection and identification, among other things.

The vehicle may further include any number of camera types, including stereo camera(s) 868, wide-view camera(s) 870, infrared camera(s) 872, surround camera(s) 874, long-range and/or mid-range camera(s) 898, and/or other camera types. The cameras may be used to capture image data around an entire periphery of the vehicle 800. The types of cameras used depends on the embodiments and requirements for the vehicle 800, and any combination of camera types may be used to provide the necessary coverage around the vehicle 800. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 8A and FIG. 8B.

The vehicle 800 may further include vibration sensor(s) 842. The vibration sensor(s) 842 may measure vibrations of components of the vehicle, such as the axle(s). For example, changes in vibrations may indicate a change in road surfaces. In another example, when two or more vibration sensors 842 are used, the differences between the vibrations may be used to determine friction or slippage of the road surface (e.g., when the difference in vibration is between a power-driven axle and a freely rotating axle).

The vehicle 800 may include an ADAS system 838. The ADAS system 838 may include a SoC, in some examples. The ADAS system 838 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 860, LIDAR sensor(s) 864, and/or a camera(s). The ACC systems may include longitudinal ACC and/or lateral ACC. Longitudinal ACC monitors and controls the distance to the vehicle immediately ahead of the vehicle 800 and automatically adjust the vehicle speed to maintain a safe distance from vehicles ahead. Lateral ACC performs distance keeping, and advises the vehicle 800 to change lanes when necessary. Lateral ACC is related to other ADAS applications such as LCA and CWS.

CACC uses information from other vehicles that may be received via the network interface 824 and/or the wireless antenna(s) 826 from other vehicles via a wireless link, or indirectly, over a network connection (e.g., over the Internet). Direct links may be provided by a vehicle-to-vehicle (V2V) communication link, while indirect links may be infrastructure-to-vehicle (12V) communication link. In general, the V2V communication concept provides information about the immediately preceding vehicles (e.g., vehicles immediately ahead of and in the same lane as the vehicle 800), while the I2V communication concept provides information about traffic further ahead. CACC systems may include either or both I2V and V2V information sources. Given the information of the vehicles ahead of the vehicle 800, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 860, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 860, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 800 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 800 if the vehicle 800 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 860, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 800 is backing up. Some RCTW systems include AEB to ensure that the vehicle brakes are applied to avoid a crash. RCTW systems may use one or more rear-facing RADAR sensor(s) 860, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 800, the vehicle 800 itself must, in the case of conflicting results, decide whether to heed the result from a primary computer or a secondary computer (e.g., a first controller 836 or a second controller 836). For example, in some embodiments, the ADAS system 838 may be a backup and/or secondary computer for providing perception information to a backup computer rationality module. The backup computer rationality monitor may run a redundant diverse software on hardware components to detect faults in perception and dynamic driving tasks. Outputs from the ADAS system 838 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 804.

In other examples, ADAS system 838 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 838 may be fed into the primary computer's perception block and/or the primary computer's dynamic driving task block. For example, if the ADAS system 838 indicates a forward crash warning due to an object immediately ahead, the perception block may use this information when identifying objects. In other examples, the secondary computer may have its own neural network which is trained and thus reduces the risk of false positives, as described herein.

The vehicle 800 may further include the infotainment SoC 830 (e.g., an in-vehicle infotainment system (IVI)). Although illustrated and described as a SoC, the infotainment system may not be a SoC, and may include two or more discrete components. The infotainment SoC 830 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 800. For example, the infotainment SoC 830 may radios, disk players, navigation systems, video players, USB and Bluetooth connectivity, carputers, in-car entertainment, Wi-Fi, steering wheel audio controls, hands free voice control, a heads-up display (HUD), an HMI display 834, a telematics device, a control panel (e.g., for controlling and/or interacting with various components, features, and/or systems), and/or other components. The infotainment SoC 830 may further be used to provide information (e.g., visual and/or audible) to a user(s) of the vehicle, such as information from the ADAS system 838, autonomous driving information such as planned vehicle maneuvers, trajectories, surrounding environment information (e.g., intersection information, vehicle information, road information, etc.), and/or other information.

The infotainment SoC 830 may include GPU functionality. The infotainment SoC 830 may communicate over the bus 802 (e.g., CAN bus, Ethernet, etc.) with other devices, systems, and/or components of the vehicle 800. In some examples, the infotainment SoC 830 may be coupled to a supervisory MCU such that the GPU of the infotainment system may perform some self-driving functions in the event that the primary controller(s) 836 (e.g., the primary and/or backup computers of the vehicle 800) fail. In such an example, the infotainment SoC 830 may put the vehicle 800 into a chauffeur to safe stop mode, as described herein.

The vehicle 800 may further include an instrument cluster 832 (e.g., a digital dash, an electronic instrument cluster, a digital instrument panel, etc.). The instrument cluster 832 may include a controller and/or supercomputer (e.g., a discrete controller or supercomputer). The instrument cluster 832 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 830 and the instrument cluster 832. In other words, the instrument cluster 832 may be included as part of the infotainment SoC 830, or vice versa.

FIG. 8D is a system diagram for communication between cloud-based server(s) and the example autonomous vehicle 800 of FIG. 8A, in accordance with some embodiments of the present disclosure. The system 876 may include server(s) 878, network(s) 890, and vehicles, including the vehicle 800. The server(s) 878 may include a plurality of GPUs 884(A)-884(H) (collectively referred to herein as GPUs 884), PCIe switches 882(A)-882(H) (collectively referred to herein as PCIe switches 882), and/or CPUs 880(A)-880(B) (collectively referred to herein as CPUs 880). The GPUs 884, the CPUs 880, and the PCIe switches may be interconnected with high-speed interconnects such as, for example and without limitation, NVLink interfaces 888 developed by NVIDIA and/or PCIe connections 886. In some examples, the GPUs 884 are connected via NVLink and/or NVSwitch SoC and the GPUs 884 and the PCIe switches 882 are connected via PCIe interconnects. Although eight GPUs 884, two CPUs 880, and two PCIe switches are illustrated, this is not intended to be limiting. Depending on the embodiment, each of the server(s) 878 may include any number of GPUs 884, CPUs 880, and/or PCIe switches. For example, the server(s) 878 may each include eight, sixteen, thirty-two, and/or more GPUs 884.

The server(s) 878 may receive, over the network(s) 890 and from the vehicles, image data representative of images showing unexpected or changed road conditions, such as recently commenced road-work. The server(s) 878 may transmit, over the network(s) 890 and to the vehicles, neural networks 892, updated neural networks 892, and/or map information 894, including information regarding traffic and road conditions. The updates to the map information 894 may include updates for the HD map 822, such as information regarding construction sites, potholes, detours, flooding, and/or other obstructions. In some examples, the neural networks 892, the updated neural networks 892, and/or the map information 894 may have resulted from new training and/or experiences represented in data received from any number of vehicles in the environment, and/or based on training performed at a datacenter (e.g., using the server(s) 878 and/or other servers).

The server(s) 878 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 890, and/or the machine learning models may be used by the server(s) 878 to remotely monitor the vehicles.

In some examples, the server(s) 878 may receive data from the vehicles and apply the data to up-to-date real-time neural networks for real-time intelligent inferencing. The server(s) 878 may include deep-learning supercomputers and/or dedicated AI computers powered by GPU(s) 884, such as a DGX and DGX Station machines developed by NVIDIA. However, in some examples, the server(s) 878 may include deep learning infrastructure that use only CPU-powered datacenters.

The deep-learning infrastructure of the server(s) 878 may be capable of fast, real-time inferencing, and may use that capability to evaluate and verify the health of the processors, software, and/or associated hardware in the vehicle 800. For example, the deep-learning infrastructure may receive periodic updates from the vehicle 800, such as a sequence of images and/or objects that the vehicle 800 has located in that sequence of images (e.g., via computer vision and/or other machine learning object classification techniques). The deep-learning infrastructure may run its own neural network to identify the objects and compare them with the objects identified by the vehicle 800 and, if the results do not match and the infrastructure concludes that the AI in the vehicle 800 is malfunctioning, the server(s) 878 may transmit a signal to the vehicle 800 instructing a fail-safe computer of the vehicle 800 to assume control, notify the passengers, and complete a safe parking maneuver.

For inferencing, the server(s) 878 may include the GPU(s) 884 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 9 is a block diagram of an example computing device(s) 900 suitable for use in implementing some embodiments of the present disclosure. Computing device 900 may include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s)), and one or more logic units 920. In at least one embodiment, the computing device(s) 900 may comprise one or more virtual machines (VMs), and/or any of the components thereof may comprise virtual components (e.g., virtual hardware components). For non-limiting examples, one or more of the GPUs 908 may comprise one or more vGPUs, one or more of the CPUs 906 may comprise one or more vCPUs, and/or one or more of the logic units 920 may comprise one or more virtual logic units. As such, a computing device(s) 900 may include discrete components (e.g., a full GPU dedicated to the computing device 900), virtual components (e.g., a portion of a GPU dedicated to the computing device 900), or a combination thereof.

Although the various blocks of FIG. 9 are shown as connected via the interconnect system 902 with lines, this is not intended to be limiting and is for clarity only. For example, in some embodiments, a presentation component 918, such as a display device, may be considered an I/O component 914 (e.g., if the display is a touch screen). As another example, the CPUs 906 and/or GPUs 908 may include memory (e.g., the memory 904 may be representative of a storage device in addition to the memory of the GPUs 908, the CPUs 906, and/or other components). In other words, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 may represent one or more links or busses, such as an address bus, a data bus, a control bus, or a combination thereof. The interconnect system 902 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 906 may be directly connected to the memory 904. Further, the CPU 906 may be directly connected to the GPU 908. Where there is direct, or point-to-point connection between components, the interconnect system 902 may include a PCIe link to carry out the connection. In these examples, a PCI bus need not be included in the computing device 900.

The memory 904 may include any of a variety of computer-readable media. The computer-readable media may be any available media that may be accessed by the computing device 900. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 904 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 900. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 906 may be configured to execute at least some of the computer-readable instructions to control one or more components of the computing device 900 to perform one or more of the methods and/or processes described herein. The CPU(s) 906 may each include one or more cores (e.g., one, two, four, eight, twenty-eight, seventy-two, etc.) that are capable of handling a multitude of software threads simultaneously. The CPU(s) 906 may include any type of processor, and may include different types of processors depending on the type of computing device 900 implemented (e.g., processors with fewer cores for mobile devices and processors with more cores for servers). For example, depending on the type of computing device 900, the processor may be an Advanced RISC Machines (ARM) processor implemented using Reduced Instruction Set Computing (RISC) or an x86 processor implemented using Complex Instruction Set Computing (CISC). The computing device 900 may include one or more CPUs 906 in addition to one or more microprocessors or supplementary co-processors, such as math co-processors.

In addition to or alternatively from the CPU(s) 906, the GPU(s) 908 may be configured to execute at least some of the computer-readable instructions to control one or more components of the computing device 900 to perform one or more of the methods and/or processes described herein. One or more of the GPU(s) 908 may be an integrated GPU (e.g., with one or more of the CPU(s) 906 and/or one or more of the GPU(s) 908 may be a discrete GPU. In embodiments, one or more of the GPU(s) 908 may be a coprocessor of one or more of the CPU(s) 906. The GPU(s) 908 may be used by the computing device 900 to render graphics (e.g., 3D graphics) or perform general purpose computations. For example, the GPU(s) 908 may be used for General-Purpose computing on GPUs (GPGPU). The GPU(s) 908 may include hundreds or thousands of cores that are capable of handling hundreds or thousands of software threads simultaneously. The GPU(s) 908 may generate pixel data for output images in response to rendering commands (e.g., rendering commands from the CPU(s) 906 received via a host interface). The GPU(s) 908 may include graphics memory, such as display memory, for storing pixel data or any other suitable data, such as GPGPU data. The display memory may be included as part of the memory 904. The GPU(s) 908 may include two or more GPUs operating in parallel (e.g., via a link). The link may directly connect the GPUs (e.g., using NVLINK) or may connect the GPUs through a switch (e.g., using NVSwitch). When combined together, each GPU 908 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 906 and/or the GPU(s) 908, the logic unit(s) 920 may be configured to execute at least some of the computer-readable instructions to control one or more components of the computing device 900 to perform one or more of the methods and/or processes described herein. In embodiments, the CPU(s) 906, the GPU(s) 908, and/or the logic unit(s) 920 may discretely or jointly perform any combination of the methods, processes and/or portions thereof. One or more of the logic units 920 may be part of and/or integrated in one or more of the CPU(s) 906 and/or the GPU(s) 908 and/or one or more of the logic units 920 may be discrete components or otherwise external to the CPU(s) 906 and/or the GPU(s) 908. In embodiments, one or more of the logic units 920 may be a coprocessor of one or more of the CPU(s) 906 and/or one or more of the GPU(s) 908.

Examples of the logic unit(s) 920 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 910 may include one or more receivers, transmitters, and/or transceivers that enable the computing device 900 to communicate with other computing devices via an electronic communication network, included wired and/or wireless communications. The communication interface 910 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 920 and/or communication interface 910 may include one or more data processing units (DPUs) to transmit data received over a network and/or through interconnect system 902 directly to (e.g., a memory of) one or more GPU(s) 908.

The I/O ports 912 may enable the computing device 900 to be logically coupled to other devices including the I/O components 914, the presentation component(s) 918, and/or other components, some of which may be built in to (e.g., integrated in) the computing device 900. Illustrative I/O components 914 include a microphone, mouse, keyboard, joystick, game pad, game controller, satellite dish, scanner, printer, wireless device, etc. The I/O components 914 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 may be include depth cameras, such as stereoscopic camera systems, infrared camera systems, RGB camera systems, touchscreen technology, and combinations of these, for gesture detection and recognition. Additionally, the computing device 900 may include accelerometers or gyroscopes (e.g., as part of an inertia measurement unit (IMU)) that enable detection of motion. In some examples, the output of the accelerometers or gyroscopes may be used by the computing device 900 to render immersive augmented reality or virtual reality.

The power supply 916 may include a hard-wired power supply, a battery power supply, or a combination thereof. The power supply 916 may provide power to the computing device 900 to enable the components of the computing device 900 to operate.

The presentation component(s) 918 may include a display (e.g., a monitor, a touch screen, a television screen, a heads-up-display (HUD), other display types, or a combination thereof), speakers, and/or other presentation components. The presentation component(s) 918 may receive data from other components (e.g., the GPU(s) 908, the CPU(s) 906, DPUs, etc.), and output the data (e.g., as an image, video, sound, etc.).

### Example Data Center

FIG. 10 illustrates an example data center 1000 that may be used in at least one embodiments of the present disclosure. The data center 1000 may include a data center infrastructure layer 1010, a framework layer 1020, a software layer 1030, and/or an application layer 1040.

As shown in FIG. 10, the data center infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1016(1)-1016(N) may correspond to a server having one or more of the above-mentioned computing resources. In addition, in some embodiments, the node C.R.s 1016(1)-10161(N) may include one or more virtual components, such as vGPUs, vCPUs, and/or the like, and/or one or more of the node C.R.s 1016(1)-1016(N) may correspond to a virtual machine (VM).

In at least one embodiment, grouped computing resources 1014 may include separate groupings of node C.R.s 1016 housed within one or more racks (not shown), or many racks housed in data centers at various geographical locations (also not shown). Separate groupings of node C.R.s 1016 within grouped computing resources 1014 may include grouped compute, network, memory or storage resources that may be configured or allocated to support one or more workloads. In at least one embodiment, several node C.R.s 1016 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1012 may configure or otherwise control one or more node C.R.s 1016(1)-1016(N) and/or grouped computing resources 1014. In at least one embodiment, resource orchestrator 1012 may include a software design infrastructure (SDI) management entity for the data center 1000. The resource orchestrator 1012 may include hardware, software, or some combination thereof.

In at least one embodiment, as shown in FIG. 10, framework layer 1020 may include a job scheduler 1033, a configuration manager 1034, a resource manager 1036, and/or a distributed file system 1038. The framework layer 1020 may include a framework to support software 1032 of software layer 1030 and/or one or more application(s) 1042 of application layer 1040. The software 1032 or application(s) 1042 may respectively include web-based service software or applications, such as those provided by Amazon Web Services, Google Cloud and Microsoft Azure. The framework layer 1020 may be, but is not limited to, a type of free and open-source software web application framework such as Apache Spark™ (hereinafter “Spark”) that may utilize distributed file system 1038 for large-scale data processing (e.g., “big data”). In at least one embodiment, job scheduler 1033 may include a Spark driver to facilitate scheduling of workloads supported by various layers of data center 1000. The configuration manager 1034 may be capable of configuring different layers such as software layer 1030 and framework layer 1020 including Spark and distributed file system 1038 for supporting large-scale data processing. The resource manager 1036 may be capable of managing clustered or grouped computing resources mapped to or allocated for support of distributed file system 1038 and job scheduler 1033. In at least one embodiment, clustered or grouped computing resources may include grouped computing resource 1014 at data center infrastructure layer 1010. The resource manager 1036 may coordinate with resource orchestrator 1012 to manage these mapped or allocated computing resources.

In at least one embodiment, software 1032 included in software layer 1030 may include software used by at least portions of node C.R.s 1016(1)-1016(N), grouped computing resources 1014, and/or distributed file system 1038 of framework layer 1020. One or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1038 of framework layer 1020. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1034, resource manager 1036, and resource orchestrator 1012 may implement any number and type of self-modifying actions based on any amount and type of data acquired in any technically feasible fashion. Self-modifying actions may relieve a data center operator of data center 1000 from making possibly bad configuration decisions and possibly avoiding underutilized and/or poor performing portions of a data center.

The data center 1000 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1000. In at least one embodiment, trained or deployed machine learning models corresponding to one or more neural networks may be used to infer or predict information using resources described above with respect to the data center 1000 by using weight parameters calculated through one or more training techniques, such as but not limited to those described herein.

In at least one embodiment, the data center 1000 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 900 of FIG. 9—e.g., each device may include similar components, features, and/or functionality of the computing device(s) 900. In addition, where backend devices (e.g., servers, NAS, etc.) are implemented, the backend devices may be included as part of a data center 1000, an example of which is described in more detail herein with respect to FIG. 10.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 900 described herein with respect to FIG. 9. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A: A method comprising: determining, based at least on sensor data obtained using one or more sensors of a machine, a first speed limit associated with a speed limit sign; determining, based at least on map data representative of a map, a second speed limit associated with the speed limit sign; determining, using one or more rules and based at least on the first speed limit and the second speed limit, a final speed limit associated with the speed limit sign; and causing, based at least on the final speed limit associated with the speed limit sign, the machine to perform one or more operations.

B: The method of paragraph A, wherein the determining the final speed limit comprises: determining that the first speed limit matches the second speed limit; and based at least on the first speed limit matching the second speed limit, determining that the final speed limit includes at least one of the first speed limit or the second speed limit.

C: The method of paragraph A or paragraph B, wherein the determining the final speed limit comprises: determining that the first speed limit is different from the second speed limit; and based at least on the first speed limit being different than the second speed limit, determining to use one of the first speed limit or the second speed limit as the final speed limit associated with the speed limit sign.

D: The method of any one of paragraphs A-C, wherein the determining to use the one of the first speed limit or the second speed limit as the final speed limit associated with the speed limit sign comprises: determining a distance traveled by the machine since the determining the first speed limit; determining whether the distance is less than or equal to a threshold distance; and one of: determining, based at least on the distance being less than or equal to the threshold distance, to use the first speed limit as the final speed limit; or determining, based at least on the distance being greater than the threshold distance, to use the second speed limit as the final speed limit.

E: The method of any one of paragraphs A-D, wherein the determining to use the one of the first speed limit or the second speed limit as the final speed limit associated with the speed limit sign comprises: determining that a time period that has elapsed since the determining the first speed limit; determining whether the time period is less than or equal to a threshold time period; and one of: determining, based at least on the time period being less than or equal to the threshold time period, to use the first speed limit as the final speed limit; or determining, based at least on the time period being greater than the threshold time period, to use the second speed limit as the final speed limit.

F: The method of any one of paragraphs A-E, wherein the determining to use the one of the first speed limit or the second speed limit as the final speed limit associated with the speed limit sign comprises: determining a probability associated with the first speed limit; determining whether the probability is greater than a threshold probability; and one of: determining, based at least on the probability being greater than the threshold probability, to use the first speed limit as the final speed limit; or determining, based at least on the probability being less than the threshold probability, to use the second speed limit as the final speed limit.

G: The method of any one of paragraphs A-F, wherein the determining to use the one of the first speed limit or the second speed limit as the final speed limit associated with the speed limit sign comprises: determining whether the machine has switched from navigating along a first road associated with the first speed limit to a second road; and one of: determining, based at least on the machine continuing to navigate along the first road, to use the first speed limit as the final speed limit; or determining, based at least on the machine switching to navigating along the second road, to use the second speed limit as the final speed limit.

H: The method of any one of paragraphs A-G, further comprising: generating a speed limit segment, the speed limit segment comprising perception speed limit data comprising at least one of a nominal perception speed limit and a conditional perception speed limit, the first speed limit based at least on the perception speed limit data, and offset data indicating a cumulative distance associated with at least one of the nominal perception speed limit and the conditional perception speed limit; generating map-based speed limit data from which the second speed limit can be obtained, the map-based speed limit data comprising: a data frame taken from streamed map data, the data frame including an updated map-based speed limit, and historical map data cached for a predetermined distance behind the machine as it moves along a path of travel, the historical map data comprising a cached map-based speed limit; and generating a speed limit profile by associating the offset data of the speed limit segment with the map-based speed limit data, wherein the determining the final speed limit is based at least on the speed limit profile.

I: The method of any one of paragraphs A-H, wherein the data frame undergoes preprocessing before the generating of the speed limit profile, the preprocessing comprising at least one of data conversion to cast the data frame in a format conducive to further processing, de-duplication of speed limit values, and removal of outdated data.

J: A system comprising: one or more processing units to: determine, based at least on sensor data obtained using one or more sensors of a machine, a first speed limit associated with a speed limit sign; determine, based at least on map data representative of a map, a second speed limit associated with the speed limit sign; determine, using one or more rules and based at least on the first speed limit and the second speed limit, a final speed limit to associated with the speed limit sign; and cause, based at least on the final speed limit associated with the speed limit sign, the machine to perform one or more operations.

K: The system of paragraph J, wherein the determination of the final speed limit comprises: determining that the first speed limit matches the second speed limit; and based at least on the first speed limit matching the second speed limit, determining that the final speed limit includes at least one of the first speed limit or the second speed limit.

L: The system of paragraph J or paragraph K, wherein the determination of the final speed limit comprises: determining that the first speed limit is different than the second speed limit; and based at least on the first speed limit being different than the second speed limit, determining to use one of the first speed limit or the second speed limit as the final speed limit associated with the speed limit sign.

M: The system of any one of paragraphs J-L, wherein the determination to use the one of the first speed limit or the second speed limit as the final speed limit associated with the speed limit sign comprises: determining a distance traveled by the machine since the determining the first speed limit; determining whether the distance is less than or equal to a threshold distance; and one of: determining, based at least on the distance being less than or equal to the threshold distance, to use the first speed limit as the final speed limit; or determining, based at least on the distance being greater than the threshold distance, to use the second speed limit as the final speed limit.

N: The system of any one of paragraphs J-M, wherein the determination to use the one of the first speed limit or the second speed limit as the final speed limit associated with the speed limit sign comprises: determining that a time period that has elapsed since the determination of the first speed limit; determining whether the time period is less than or equal to a threshold time period; and one of: determining, based at least on the time period being less than or equal to the threshold time period, to use the first speed limit as the final speed limit; or determining, based at least on the time period being greater than the threshold time period, to use the second speed limit as the final speed limit.

O: The system of any one of paragraphs J-N, wherein the determination to use the one of the first speed limit or the second speed limit as the final speed limit associated with the speed limit sign comprises: determining a probability associated with the first speed limit; determining whether the probability is greater than a threshold probability; and one of: determining, based at least on the probability being greater than the threshold probability, to use the first speed limit as the final speed limit; or determining, based at least on the probability being less than the threshold probability, to use the second speed limit as the final speed limit.

P: The system of any one of paragraphs J-O, wherein the determination to use the one of the first speed limit or the second speed limit as the final speed limit associated with the speed limit sign comprises: determining whether the machine has switched from navigating along a first road associated with the first speed limit to a second road; and one of: determining, based at least on the machine continuing to navigate along the first road, to use the first speed limit as the final speed limit; or determining, based at least on the machine switching to navigating along the second road, to use the second speed limit as the final speed limit.

Q: The system of any one of paragraphs J-P, wherein the one or more processing units are further to: generate a speed limit segment, the speed limit segment comprising: perception speed limit data comprising at least one of a nominal perception speed limit and a conditional perception speed limit, the first speed limit based upon the perception speed limit data, and offset data indicating a cumulative distance associated with at least one of the nominal perception speed limit and the conditional perception speed limit; generate map-based speed limit data from which the second speed limit can be obtained, the map-based speed limit data comprising a data frame taken from streamed map data, the data frame including an updated map-based speed limit, and historical map data cached for a predetermined distance behind the machine as it moves along a path of travel, the historical map data comprising a cached map-based speed limit; and generate a speed limit profile by associating the offset data of the speed limit segment with the map-based speed limit data, wherein the determination of the final speed limit is based at least on the speed limit profile.

R: The system of any one of paragraphs J-Q, wherein the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing generative AI operations; a system for performing operations using a large language model; a system for performing deep learning operations; a system implemented using an edge device; a system implemented using a robot; a system for performing conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

S: A processor comprising: one or more processing units to perform fusion of map-based speed limit data and perception speed limit data, wherein the fusion employs at least one rule to publish an output speed limit selected from one of the map-based speed limit data, the perception speed limit data, and cached map-based speed limit data stored in a memory unit in communication with the one or more processing units.

T: The processor of paragraph S, wherein the processor is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing generative AI operations; a system for performing operations using a large language model; a system for performing deep learning operations; a system implemented using an edge device; a system implemented using a robot; a system for performing conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method comprising:
determining, based at least on sensor data obtained using one or more sensors of a machine, a first speed limit associated with a speed limit sign;
determining, based at least on map data representative of a map, a second speed limit associated with the speed limit sign;
determining, using one or more rules and based at least on the first speed limit and the second speed limit, a final speed limit associated with the speed limit sign; and
causing, based at least on the final speed limit associated with the speed limit sign, the machine to perform one or more operations.

2. The method of claim 1, wherein the determining the final speed limit comprises:
determining that the first speed limit matches the second speed limit; and
based at least on the first speed limit matching the second speed limit, determining that the final speed limit includes at least one of the first speed limit or the second speed limit.

3. The method of claim 1, wherein the determining the final speed limit comprises:
determining that the first speed limit is different from the second speed limit; and
based at least on the first speed limit being different than the second speed limit, determining to use one of the first speed limit or the second speed limit as the final speed limit associated with the speed limit sign.

4. The method of claim 3, wherein the determining to use the one of the first speed limit or the second speed limit as the final speed limit associated with the speed limit sign comprises:
determining a distance traveled by the machine since the determining the first speed limit;
determining whether the distance is less than or equal to a threshold distance; and
one of:
determining, based at least on the distance being less than or equal to the threshold distance, to use the first speed limit as the final speed limit; or
determining, based at least on the distance being greater than the threshold distance, to use the second speed limit as the final speed limit.

5. The method of claim 3, wherein the determining to use the one of the first speed limit or the second speed limit as the final speed limit associated with the speed limit sign comprises:
determining that a time period that has elapsed since the determining the first speed limit;
determining whether the time period is less than or equal to a threshold time period; and
one of:
determining, based at least on the time period being less than or equal to the threshold time period, to use the first speed limit as the final speed limit; or
determining, based at least on the time period being greater than the threshold time period, to use the second speed limit as the final speed limit.

6. The method of claim 3, wherein the determining to use the one of the first speed limit or the second speed limit as the final speed limit associated with the speed limit sign comprises:
determining a probability associated with the first speed limit;
determining whether the probability is greater than a threshold probability; and
one of:
determining, based at least on the probability being greater than the threshold probability, to use the first speed limit as the final speed limit; or
determining, based at least on the probability being less than the threshold probability, to use the second speed limit as the final speed limit.

7. The method of claim 3, wherein the determining to use the one of the first speed limit or the second speed limit as the final speed limit associated with the speed limit sign comprises:
determining whether the machine has switched from navigating along a first road associated with the first speed limit to a second road; and
one of:
determining, based at least on the machine continuing to navigate along the first road, to use the first speed limit as the final speed limit; or
determining, based at least on the machine switching to navigating along the second road, to use the second speed limit as the final speed limit.

8. The method of claim 1, further comprising:
generating a speed limit segment, the speed limit segment comprising
perception speed limit data comprising at least one of a nominal perception speed limit and a conditional perception speed limit, the first speed limit based at least on the perception speed limit data, and
offset data indicating a cumulative distance associated with at least one of the nominal perception speed limit and the conditional perception speed limit;
generating map-based speed limit data from which the second speed limit can be obtained, the map-based speed limit data comprising:
a data frame taken from streamed map data, the data frame including an updated map-based speed limit, and
historical map data cached for a predetermined distance behind the machine as it moves along a path of travel, the historical map data comprising a cached map-based speed limit; and
generating a speed limit profile by associating the offset data of the speed limit segment with the map-based speed limit data,
wherein the determining the final speed limit is based at least on the speed limit profile.

9. The method of claim 8, wherein the data frame undergoes preprocessing before the generating of the speed limit profile, the preprocessing comprising at least one of data conversion to cast the data frame in a format conducive to further processing, de-duplication of speed limit values, and removal of outdated data.

10. A system comprising:
one or more processing units to:
determine, based at least on sensor data obtained using one or more sensors of a machine, a first speed limit associated with a speed limit sign;
determine, based at least on map data representative of a map, a second speed limit associated with the speed limit sign;
determine, using one or more rules and based at least on the first speed limit and the second speed limit, a final speed limit to associated with the speed limit sign; and
cause, based at least on the final speed limit associated with the speed limit sign, the machine to perform one or more operations.

11. The system of claim 10, wherein the determination of the final speed limit comprises:
determining that the first speed limit matches the second speed limit; and
based at least on the first speed limit matching the second speed limit, determining that the final speed limit includes at least one of the first speed limit or the second speed limit.

12. The system of claim 10, wherein the determination of the final speed limit comprises:
determining that the first speed limit is different than the second speed limit; and
based at least on the first speed limit being different than the second speed limit, determining to use one of the first speed limit or the second speed limit as the final speed limit associated with the speed limit sign.

13. The system of claim 12, wherein the determination to use the one of the first speed limit or the second speed limit as the final speed limit associated with the speed limit sign comprises:
determining a distance traveled by the machine since the determining the first speed limit;
determining whether the distance is less than or equal to a threshold distance; and
one of:
determining, based at least on the distance being less than or equal to the threshold distance, to use the first speed limit as the final speed limit; or
determining, based at least on the distance being greater than the threshold distance, to use the second speed limit as the final speed limit.

14. The system of claim 12, wherein the determination to use the one of the first speed limit or the second speed limit as the final speed limit associated with the speed limit sign comprises:
determining that a time period that has elapsed since the determination of the first speed limit;
determining whether the time period is less than or equal to a threshold time period; and
one of:
determining, based at least on the time period being less than or equal to the threshold time period, to use the first speed limit as the final speed limit; or
determining, based at least on the time period being greater than the threshold time period, to use the second speed limit as the final speed limit.

15. The system of claim 12, wherein the determination to use the one of the first speed limit or the second speed limit as the final speed limit associated with the speed limit sign comprises:
determining a probability associated with the first speed limit;
determining whether the probability is greater than a threshold probability; and
one of:
determining, based at least on the probability being greater than the threshold probability, to use the first speed limit as the final speed limit; or
determining, based at least on the probability being less than the threshold probability, to use the second speed limit as the final speed limit.

16. The system of claim 12, wherein the determination to use the one of the first speed limit or the second speed limit as the final speed limit associated with the speed limit sign comprises:
determining whether the machine has switched from navigating along a first road associated with the first speed limit to a second road; and
one of:
determining, based at least on the machine continuing to navigate along the first road, to use the first speed limit as the final speed limit; or
determining, based at least on the machine switching to navigating along the second road, to use the second speed limit as the final speed limit.

17. The system of claim 10, wherein the one or more processing units are further to:
generate a speed limit segment, the speed limit segment comprising:
perception speed limit data comprising at least one of a nominal perception speed limit and a conditional perception speed limit, the first speed limit based upon the perception speed limit data, and
offset data indicating a cumulative distance associated with at least one of the nominal perception speed limit and the conditional perception speed limit;
generate map-based speed limit data from which the second speed limit can be obtained, the map-based speed limit data comprising
a data frame taken from streamed map data, the data frame including an updated map-based speed limit, and
historical map data cached for a predetermined distance behind the machine as it moves along a path of travel, the historical map data comprising a cached map-based speed limit; and
generate a speed limit profile by associating the offset data of the speed limit segment with the map-based speed limit data,
wherein the determination of the final speed limit is based at least on the speed limit profile.

18. The system of claim 10, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing generative AI operations;
a system for performing operations using a large language model;
a system for performing deep learning operations;
a system implemented using an edge device;
a system implemented using a robot;
a system for performing conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

19. A processor comprising:
one or more processing units to perform fusion of map-based speed limit data and perception speed limit data, wherein the fusion employs at least one rule to publish an output speed limit selected from one of the map-based speed limit data, the perception speed limit data, and cached map-based speed limit data stored in a memory unit in communication with the one or more processing units.

20. The processor of claim 19, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing generative AI operations;
a system for performing operations using a large language model;
a system for performing deep learning operations;
a system implemented using an edge device;
a system implemented using a robot;
a system for performing conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
